(19) United States
(12) Patent Application Publication
(10) Pub. No.: US 2026/0170911 A1
(43) Pub. Date: Jun. 18, 2026

(54) EMPLOYING ARTIFICIAL INTELLIGENCE TO MODIFY CONTENT IN A GAME STREAMING ENVIRONMENT

(71) Applicant: IGT, Las Vegas, NV (US)

(72) Inventors: Michael Russ, Styria (AT); Stefan Keilwert, St. Josef (AT); Soheil Latifi, Ontario (CA)

(21) Appl. No.: 18/978,677

(22) Filed: Dec. 12, 2024

(51) Int. Cl. G07F 17/32

(52) U.S. Cl. CPC G07F 17/323; G07F 17/3211; G07F 17/3227; G07F 17/3237

(57) ABSTRACT

Systems and methods that receive, from a streaming device, data associated with first content corresponding to an event and determine whether any content modification events occur in association with the data received from the streaming device. Responsive to the determination being that a content modification event occurred in association with the data received from the streaming device, the systems and methods automatically modify the first content corresponding to the event to second, different content corresponding to the event and communicate the second, different content corresponding to the event to a device. At least one of the determination and the automatic modification occur based on a use of an artificial intelligence model.

### BACKGROUND

In various embodiments, responsive to a determination that a content modification event occurred in association with data received from a streaming device and associated with first content corresponding to an event, the systems and methods of the present disclosure automatically modify the first content corresponding to the event to second, different content corresponding to the event, wherein at least one of the determination and the automatic modification occur based on a use of an artificial intelligence model.

Gaming machines may provide users awards in primary games. Gaming machines generally require the user to place a wager to activate the primary game. The award may be based on the user obtaining a winning symbol or symbol combination and on the amount of the wager.

### BRIEF DESCRIPTION OF THE SEVERAL VIEWS OF THE DRAWINGS

FIG. 1A is an example configuration of an architecture of a plurality of different components of the system of the present disclosure.

FIG. 1B is an example configuration of another architecture of a plurality of different components of the system of the present disclosure.

FIG. 1C is an example configuration of another architecture of a plurality of different components of the system of the present disclosure.

FIG. 2 is an example graphical user interface displayed to a viewer of a client device in association with a live stream of a gaming session occurring at a streaming device.

FIG. 3 is a schematic block diagram of one embodiment of an electronic configuration of an example electronic gaming machine of the present disclosure.

FIGS. 4A and 4B are perspective views of example alternative embodiments of an electronic gaming machine of the present disclosure.

FIG. 4C is a front view of an example personal gaming device of the present disclosure.

### DETAILED DESCRIPTION

In various embodiments, responsive to a determination that a content modification event occurred in association with data received from a streaming device and associated with first content corresponding to an event, the systems and methods of the present disclosure automatically modify the first content corresponding to the event to second, different content corresponding to the event, wherein at least one of the determination and the automatic modification occur based on a use of an artificial intelligence model.

In certain embodiments, the systems of the present disclosure monitor for one or more events and/or activities associated with a streaming service facilitated by a streaming platform. In certain such embodiments, the system receives, from a streaming device operating with the streaming platform, data associated with the events and/or activities occurring (and/or scheduled to occur) at the streaming device. In certain such embodiments, the system additionally or alternative receives, from a client device operating with the streaming platform, data associated with one or more parameters of the client device and/or data associated with a user of the client device. In these embodiments, using one or more artificial intelligence predictive models, the system generates correlations between the received data and one or more notification data clusters (e.g., historical data relating to prior occurrences to such events and/or activities) associated with one or more of the streaming device, the client device, the streaming platform and/or a particular user (or group of users) associated with such devices. The system then determines, based at least in part on the correlations, whether a notification event occurred in association with one or more users (of one or more streaming devices and/or client devices) and/or causes a notification event to occur in association with one or more users (of one or more streaming devices and/or client devices). Put differently, the system employs a machine learning model (e.g., a large language model) or other artificial intelligence programs, to determine if any events and/or activities occurring and/or predicted to occur in association with the streaming platform warrant the occurrence of a notification event for one or more users of devices in communication with the streaming platform.

In certain embodiments, following a determination that a notification event occurs, the system of the present disclosure generates and communicates one or more notifications regarding the occurrence of the notification event, such one or more notifications to one or more users (or potential users) of one or more devices in association with an opportunity to view and/or wager on plays of games occurring at (or otherwise in association with) a streaming device. In these embodiments, the notifications take the form of one or more targeted messages to different users that are sent responsive to different events occurring in association with a streaming environment. In certain such embodiments, the system employs the artificial intelligence predictive model to additionally or alternatively determine the notification communicated to one or more current or potential users. For example, using an artificial intelligence predictive model trained on prior notifications to different users and the relative success rate of such prior notifications (e.g., did a prior notification to a specific user elicit an action and if so, was that action the intended action expected from the notification), the system determines when to convey one or more notifications, what content to include in such notifications, how to convey such notifications and/or to whom to convey such notifications.

In certain embodiments in which the system utilizes artificial intelligence to differentiate the notifications provided to different users, the system (and more specifically the artificial intelligence predictive model) utilizes one or more attributes of one or more users (or potential users) of a client device, a user of a streaming device, the client device and/or the streaming device to determine whether or not to communicate a notification to a particular user and/or the content of such a notification. Accordingly, in certain embodiments, the system of the present disclosures utilizes one or more artificial intelligence predictive models (such as, but not limited to, convolutional collaborative filter networks, artificial neural networks, supervised machine learning models and/or unsupervised machine learning models) to determine different content to communicate to different users to make such potential users aware of the happenings occurring at one or more streaming devices which such users may have a particular interest in. Put differently, the generative-model-enabled notification system of these embodiments operates to adjust the notifications to a single user (i.e., personalized notifications) and/or a group of users (i.e., targeted audience notifications) in a unique way so that it is increasingly appealing to users. Such a configuration enables users to stay abreast of developments in the streaming platform and not miss out of opportunities that occur in the streaming platform, such as opportunities to place wagers and win awards.

In certain additional or alternative embodiments, the systems of the present disclosure monitor for one or more potential wagering events occurring in association with a streaming platform. In certain such embodiments, the system receives, from a streaming device operating with a streaming platform, data associated with certain events which may occur at the streaming device and/or data associated with a user of the streaming device. In certain such embodiments, the system additionally or alternative receives, from a client device operating with the streaming platform, data associated with one or more parameters of the client device and/or data associated with a user of the client device. In these embodiments, using one or more artificial intelligence predictive models, the system generates correlations between the received data and one or more wagering data clusters (e.g., historical wagering data relating to prior occurrences of such events that may occur) associated with one or more of the streaming device, the client device, the streaming platform and/or a particular user (or group of users) associated with such devices. The system then determines, based at least in part on the correlations, whether a wagering opportunity event occurred in association with one or more users (of one or more streaming devices and/or client devices) and if so, one or more parameters of one or more wagers made available to one or more users to place in association with the occurrence of the wagering opportunity event. In other words, the system of these embodiments employs a machine learning model (e.g., a large language model) or other artificial intelligence programs to determine when the wagering opportunity event occurs and/or the wagering opportunity made available to one or more current or potential users. For example, using an artificial intelligence predictive model trained on prior wagering opportunities made available to different users and the relative success rate of such prior wagering opportunities (e.g., was a wager corresponding with a prior wagering opportunity event placed), the system determines when to make one or more wagering opportunities available, which wagering opportunities to make available, and/or to whom to make such wagering opportunities available.

In certain embodiments in which the system utilizes artificial intelligence to differentiate the wagering opportunities made available to different users, the system (and more specifically the artificial intelligence predictive model) utilizes one or more attributes of one or more users (e.g., wagering history, such as amounts won/lost, frequency of play, in association with a streaming platform, status or ranking obtained in the streaming environment, and/or user requests), to determine whether or not to make any wagering opportunities available (and if so, which ones) to any particular users of any devices. Accordingly, in certain embodiments, the system of the present disclosures utilizes one or more artificial intelligence predictive models (such as, but not limited to, convolutional collaborative filter networks, artificial neural networks, supervised machine learning models and/or unsupervised machine learning models) to determine different wagering opportunities to make available to different users to customize the gaming experience of these different users. As such, the generative-model-enabled wagering system of these embodiments operates to offer unique wagering options to a single user (i.e., personalized wagering) and/or a group of users (i.e., targeted audience wagering) in a unique way so that it is increasingly appealing to users.

In certain additional or alternative embodiments, the systems of the present disclosure monitor for content generated in association with a streaming platform. In certain such embodiments, the system receives, from a streaming device operating with a streaming platform, content data associated with the streaming device and/or content data associated with a user of the streaming device. In certain such embodiments, the system additionally or alternative receives, from a client device operating with the streaming platform, data associated with one or more parameters of the client device and/or data associated with a user of the client device. In these embodiments, using one or more artificial intelligence predictive models, the system generates correlations between the received content data and one or more content data clusters (e.g., historical content data) associated one or more of the streaming device, the client device, the streaming platform and/or a particular user (or group of users) associated with such devices. The system then determines, based at least in part on the correlations, whether to modify any content in association with one or more users (of one or more streaming devices and/or client devices) and if so, one or more parameters of such modified content. Put differently, the system of these embodiments employs a machine learning model (e.g., a large language model) or other artificial intelligence programs to determine when a content modification event occurs and/or the modification of any content in association with an occurrence of a content modification event. For example, using an artificial intelligence predictive model trained on prior content associated with the streaming platform, the system determines when to modify certain content and what such modifications entail.

In certain embodiments in which the system utilizes artificial intelligence to differentiate the content provided to different users based on the same source content, the system (and more specifically the artificial intelligence predictive model) utilizes one or more attributes of one or more users (e.g., wagering history in association with a streaming platform, status or ranking obtained in the streaming environment, and/or user requests), to determine whether or not to make any modifications to any content delivered to any particular users of any devices and if so, which modifications to make. Accordingly, in certain embodiments, the system of the present disclosures utilizes one or more artificial intelligence predictive models (such as, but not limited to, convolutional collaborative filter networks, artificial neural networks, supervised machine learning models and/or unsupervised machine learning models) to determine different ways to personalize content to communicate to different users. As such, the generative-model-enabled content modification system of these embodiments operates to offer unique content to a single user (i.e., personalized content) and/or a group of users (i.e., targeted audience content) in a unique way so that it is increasingly appealing to users. In other words, the system of these embodiments employs a single game event at least partially originating with a streaming device and uses generative artificial intelligence to change part of how that single game event is presented to create multiple different streams to different respective users.

In various embodiments, the present disclosure is directed to a system including various components and/or sub-systems that operate individually and/or collectively to enable a first user to participate in a stream and potentially reap certain benefits (in the form of awards, notoriety and interactions with other users) associated with such participation. In various such embodiments, the various components and/or sub-systems operate individually and/or collectively to capture stream data and upload the captured stream data. The various components and/or sub-systems additionally or alternatively operate individually and/or collectively to enable one or more second users to view and/or interact with the captured stream and/or a modification of the captured stream to also potentially reap certain benefits (in the form of awards, notoriety and interactions with other users).

In various embodiments, the streaming system of the present disclosure employs a streaming device that operates to generate gaming content. In certain embodiments, the streaming device comprises a streaming server that initiates one or more gaming sessions for distribution to certain users, such as users that subscribe to gaming content from the streaming server. In certain embodiments, the streaming device additionally or alternatively comprises a streaming electronic gaming machine that enables a first user (e.g., a streamer or influencer at the streaming electronic gaming machine) to participate in one or more gaming sessions. In certain embodiments, the streaming device additionally or alternatively comprises a streaming personal gaming device that enables a first user (e.g., a streamer or influencer at the streaming personal gaming device) to participate in one or more gaming sessions. In these different embodiments, the streaming system of the present disclosure further employs a client device, such as viewing electronic gaming machine or a viewing personal gaming device, that enables a second user (e.g., a viewer or follower at a client device) to view, interact with and/or participate in the one or more gaming sessions occurring at the streaming device.

In certain embodiments, the streaming device communicates data associated with the gaming sessions and/or data associated with the first user which is independent of the gaming sessions to one or more components of a distinct streaming platform. The one or more components of the distinct and independently operating streaming platform utilize the communicated data to offer various features and functions to the second users at the client devices. In certain embodiments, the streaming device operates as the streaming platform to utilize data associated with the gaming sessions and/or data associated with the first user which is independent of the gaming sessions to offer various features and functions to the second users at the client devices. For example, a streaming server operating as the streaming device utilizes, without a separate streaming platform, data associated with the gaming sessions to offer various features and functions to the users at client devices that subscribe to gaming content from the streaming server.

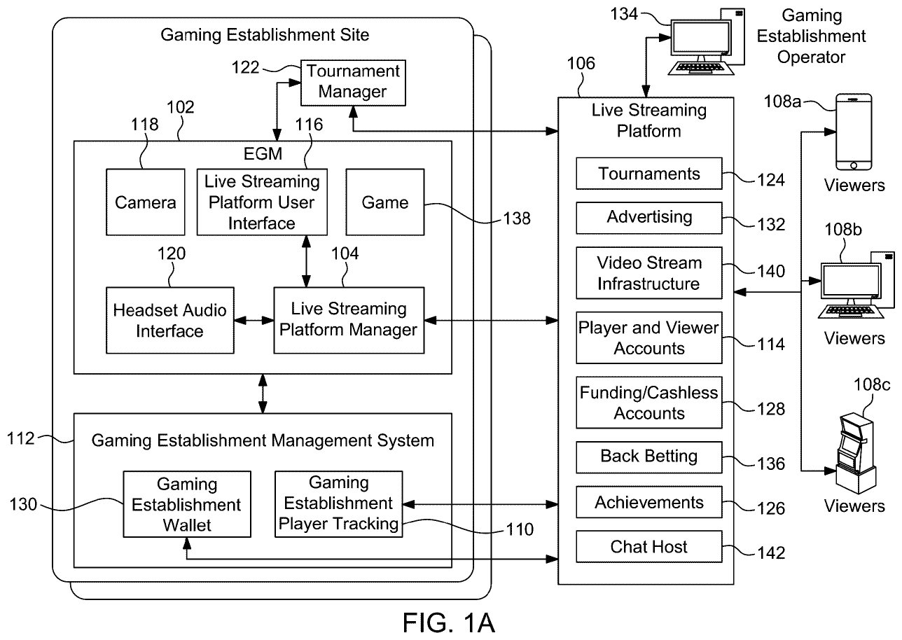

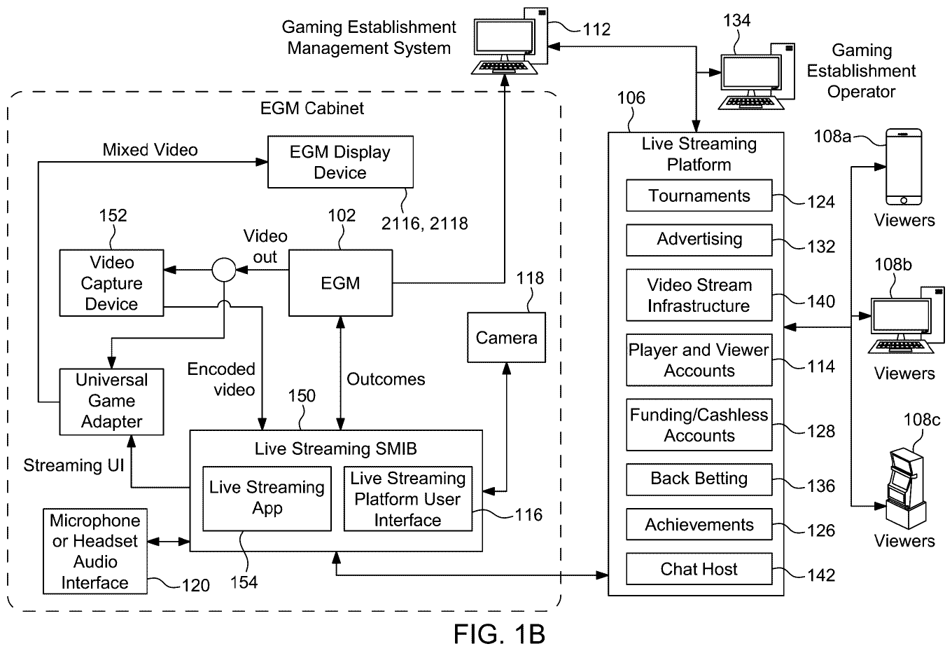

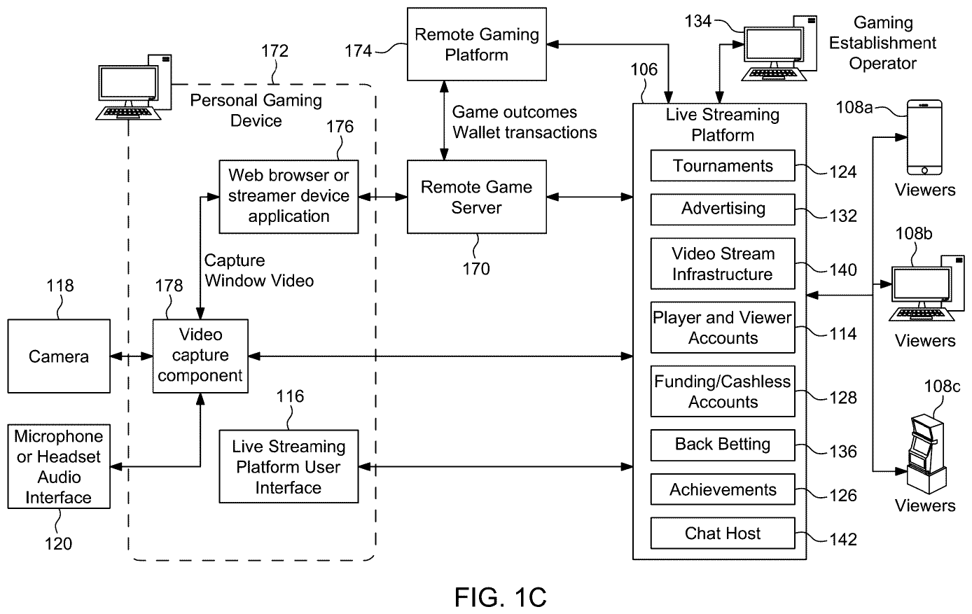

In certain embodiments, the client device and/or the streaming device comprises an electronic gaming machine (“EGM”) including, but not limited to, a slot machine, a video poker machine, a video lottery terminal, a terminal associated with an electronic table game, a terminal associated with a live table game, a video keno machine, a video bingo, and/or a sports betting terminal (that offers wagering games and/or sports betting opportunities). In certain such embodiments, an EGM operating as the streaming device interacts with the streaming platform to facilitate the streaming system of the present disclosure as well as foster any interactions between a user of the EGM and/or one or more viewers. In these embodiments, the EGM communicates data regarding one or more aspects of a gaming session to one or more components of the streaming platform which operate to publish content to zero, one or more client devices. For example, as seen in FIG. 1A, the system employs an EGM 102 as a streaming device that includes or is otherwise associated with a live streaming platform manager 104 that interacts with a live streaming platform 106 to enable a live stream of one or more events occurring in association with the streaming EGM and/or interactions between the streaming EGM and one or more client devices 108a, 108b, 108c.

In certain embodiments, the client device and/or the streaming device comprises a component of a gaming establishment management system in communication with an EGM, such as a slot machine interface board (“SMIB”) in communication with an EGM. In certain additional or alternative embodiments, the client device and/or the streaming device comprises a component, such as a SMIB, that is in communication with an EGM and that operates independent of a gaming establishment management system. In certain such embodiments, the device operating as the streaming device interacts with the streaming platform to facilitate the streaming system of the present disclosure as well as foster any interactions between a user of the EGM and/or one or more viewers. In these embodiments, the device operating as the streaming device receives data from the EGM regarding one or more aspects of a gaming session of the EGM, and communicates part or all of such data to one or more components of the streaming platform which operate to publish content to zero, one or more client devices. For example, as seen in FIG. 1B, the system employs a streaming SMIB 150 which operates with an EGM 102 to capture data associated with the EGM and interact with a live streaming platform 106 to enable a live stream of one or more events occurring in association with the EGM and/or interactions between the streaming SMIB (and/or associated EGM) and one or more client devices 108a, 108b, 108c.

In certain embodiments, the client device and/or the streaming device comprises a personal gaming device. In certain such embodiments in which the personal gaming device operates as the streaming device, the personal gaming device operates with a remote game server to offer one or more plays of one or more games independent of any EGM and any SMIB associated with the EGM. In certain such embodiments, the personal gaming device and/or remote game server interacts with the streaming platform to facilitate the streaming system of the present disclosure as well as foster any interactions between a user of the personal gaming device and/or one or more viewers. In these embodiments, the personal gaming device and/or remote game server communicate data regarding one or more aspects of a gaming session to one or more components of the streaming platform which operate to publish content to zero, one or more client devices. For example, as seen in FIG. 1C, the system employs a remote game server 170 that operates with a personal gaming device 172, such as a mobile device or a personal computer, and remote gaming platform 174 (which interacts with a live streaming platform 106) to enable, via an internet browser or application 176 of the personal gaming device, a live stream of one or more events occurring in association with the personal gaming device 172, one or more events occurring in association with the remote game server 170 and/or one or more interactions between the personal gaming device 172 and one or more client devices 108a, 108b, 108c.

In certain embodiments, upon an occurrence of a user identification event, the system enables a user at a streaming device to log into a streaming platform account associated with the user. In different embodiments, the user logs into a streaming platform account via one or more of: the user inserting a streaming platform identification card (that has an encoded user identification number that uniquely identifies the user) into a card reader of the streaming device; the user inserting a player tracking card that functions as a streaming platform identification card (that has an encoded user identification number that uniquely identifies the user) into a card reader of a streaming device; an establishment of a wireless communication link between the streaming device and a mobile device executing an application associated with an identified user; the utilization of any suitable biometric technology or ticket technology to identify a user associated with a gaming session occurring at a streaming device. In certain embodiments, with reference to FIG. 1A, wherein the system includes or is otherwise in communication with a gaming establishment player tracking system 110 of a gaming establishment management system 112, the user identification occurs in association with a user logging into the player tracking system from an EGM 102. In this embodiment, the EGM communicates the user identification data to one or more components of the live streaming platform 106 (e.g., a server of the live streaming platform) which log the user into a live streaming account 114 associated with the user and maintained in association with the live streaming platform. In certain embodiments wherein the system is separate from and not in communication with a gaming establishment player tracking system, the user identification occurs in association with a user logging into the streaming platform from the streaming device (such as by the user entering an identification and password or login code at the streaming device). In this embodiment, the streaming device communicates the user identification data to one or more components of the streaming platform which log the user into the streaming account associated with the user.

In certain embodiments, in association with a user logging into a streaming platform account of the streaming platform from a streaming device, the system enables the user to enable/disable certain components of the streaming device. In certain such embodiments, the system employs one or more artificial intelligence predictive models to determine which components of the streaming device to enable/disable and to execute (or suggest to the user) the enablement/disablement of such determined components. In certain embodiments, in association with a user logging into a streaming platform account of the streaming platform from a streaming device, the system enables the user to modify the settings or parameters of certain components of the streaming device. In these embodiments, as seen in FIGS. 1A to 1C, as part of configuring the streaming device to operate with the live streaming platform, the system utilizes a live streaming platform user interface 116 to enable a user to modify zero, one or more aspects of the streaming device as they relate to how the streaming device operates with the live streaming platform.

In one such embodiment, the system enables the user to modify (and/or employs an artificial intelligence predictive model to modify) the use of one or more display devices of the streaming device and/or one or more display devices separate from, but associated with, the streaming device. For example, the system enables the user to enable or disable one or more display devices of the streaming device from displaying the images captured by the streaming device which are displayed to the viewers. In another example, the system additionally or alternatively enables the user to modify the settings of the display device(s) of the streaming device, such as modifying the screen layout of the streaming device by selecting an area of the display device to display the stream displayed to the viewers, or modifying whether to utilize a split screen to display the stream displayed to the remote users.

In another such embodiment, the system enables the user to modify (and/or employs an artificial intelligence predictive model to modify) the use of one or more cameras of the streaming device and/or one or more cameras separate from, but associated with, the streaming device. For example, as seen in FIGS. 1A to 1C, since one or more cameras 118 of the streaming device may be used to capture data of the user playing the streaming device, the system enables the user to enable or disable the camera(s) of the streaming device from capturing one or more images of the user playing the streaming device. In another example, the system additionally or alternatively enables the user to modify the settings of the camera(s) of the streaming device, such as modifying the resolution of the camera, modifying the color settings of the camera (e.g., to capture images in color or black and white), modifying the use of a green screen.

In another such embodiment, the system enables the user to modify (and/or employs an artificial intelligence predictive model to modify) the use of one or more sound generating devices, such as speakers, of the streaming device and/or one or more sound generating devices separate from, but associated with, the streaming device. For example, since one or more speakers of the streaming device may be used to generate sounds communicated from one or more viewers at one or more client devices, such as comments made by one or more viewers, the system enables the user to enable or disable the speaker(s) of the streaming device. In another example, the system additionally or alternatively enables the user to modify the settings of the speaker(s) of the streaming device, such as modifying the volume of the speakers.

In another such embodiment, the system enables the user to modify (and/or employs an artificial intelligence predictive model to modify) the use of one or more sound capture devices, such as microphones, of the streaming device and/or one or more sound capture devices separate from, but associated with, the streaming device. For example, since one or more microphones of the streaming device may be used to capture the sounds at the streaming device, such as comments made by the user, the system enables the user to enable or disable the microphone(s) of the streaming device. In another example, the system additionally or alternatively enables the user to modify the settings of the microphone(s) of the streaming device, such as modifying the sensitivity of the microphone(s).

In another embodiment, in addition to or alternatively from modifying the settings of one or more components of the streaming device and/or components separate from, but associated with, the streaming device, the system enables a user to connect or otherwise pair a peripheral device with the streaming device and utilize the connected peripheral device in association with the capturing of data for the stream. That is, the system of this embodiment enables the user to connect one or more peripherals to the streaming device to further enhance the broadcasting experience.

In one embodiment, the peripheral device includes a mobile device (with or without a camera) wherein the system enables a user to wirelessly connect or otherwise pair the mobile device to the streaming device such that the user can interact with their audience of viewers using the mobile device. In one such embodiment, the wireless communication link includes a direct pairing such that when the user of the mobile device is currently located at or otherwise engaging with a streaming device, a direct pairing or linkage occurs between the mobile device and the streaming device utilizing one or more wireless communication protocols, such as Bluetooth™ signals, Bluetooth™ Low Energy (“BLE”) signals, one or more cellular communication standard (e.g., 3G, 4G, 5G, 6G, LTE) signals, one or more Wi-Fi compatible standard signals and/or one or more short range communication signals, such as near field communication (“NFC”) signals protocol). In another such embodiment, the wireless communication link includes an indirect pairing such that when the user of the mobile device is currently located at or otherwise engaging with a streaming device and wirelessly connected to one or more servers, such as servers of a gaming establishment, an indirect pairing or linkage occurs between the mobile device and the streaming device via the one or more servers. In another embodiment, in addition to or alternative from using the mobile device as a peripheral device associated with the streaming device, the system enables the user to utilize a paired mobile device (which is running a mobile device application configured to interface with the streaming device) to display a streaming platform user interface such that the user can adjust one or more settings on the streaming device which pertain to the stream.

In another embodiment, the peripheral device includes a headset (including a microphone) wherein the system enables a user to connect or otherwise pair the headset (e.g., headset audio interface 120 of FIGS. 1A to 1C) to the streaming device such that the user can speak with their audience of viewers at client devices. In this example, if the headset is a wired headset, the system enables the user to connect to the streaming device over USB Audio, standard analog headphone and speaker jacks, or optical inputs and outputs. On the other hand, if the headset is a wireless headset, the system enables the user to connect to the streaming device via establishing a wireless communication link with the headset. In these embodiments, if the peripheral device requires a power source, the system further enables the user to power such connected peripheral devices via one or more USB power outlets and/or wireless charging devices.

In certain embodiments, in addition to enabling a user to connect a peripheral device to the streaming device, the system adjusts (and/or employs an artificial intelligence predictive model to adjust) one or more settings of the streaming device responsive to the detection of a connected peripheral device. For example, upon the streaming device detecting that headphones are connected, the system mutes one or more speakers of the streaming device and routes one or more sound outputs to the headphones so that the risk of echo when the user is speaking into their headphone microphone is minimized. In one such example, the system routes all sound outputs to the headphones. In another such example, the system routes certain sound outputs to the headphones but continues routing other sound outputs, such as sounds associated with large jackpots, sounds occurring during certain in-game bonuses, or other sounds that contribute to the general ambiance of the gaming establishment for exciting events, to the speakers of the streaming device.

It should be appreciated that while certain adjustments to one or more components of the streaming device occur in association with a user logging into a streaming platform account of the streaming platform, in certain additional embodiments, one or more adjustments to one or more components of the streaming device occur based on the stream of the user's gaming session. In these embodiments, the streaming device displays (either continuously or responsive to one or more inputs made by the user during the user's gaming session) one or more streaming platform user interfaces which enable the user to change (and/or employs an artificial intelligence predictive model to change) one or more configurations of the streaming device that pertain to the broadcasted stream of the user's gaming session. For example, since one or more display devices of the streaming device and/or speakers of the streaming device may be utilized to provide the user the stream which is broadcasted to one or more viewers at client devices, the system gives the user of the streaming device instant feedback and enables the user to modify one or more settings of any suitable component utilized to produce the stream, such as a camera of the streaming device, a camera paired with the streaming device, a microphone of the streaming device or a microphone paired with the streaming device.

In another embodiment, in addition to or alternatively from adjusting one or more settings of the streaming device based on the feedback of the user, the system displays to the user certain information regarding the user's stream to provide the user at the streaming device a more immersive experience to foster more interaction with the viewers at the client devices. For example, the streaming device utilizes a user feedback display to display to the user statistics about how many viewers are viewing the user's play online at the current point in time. In another example, the streaming device utilizes a user feedback display to inform the user at the streaming device of a current live chat associated with the user's gaming session so that the user can respond (using a microphone to provide comments and/or answer requests from viewers). In another example, the streaming device utilizes a user feedback display to display non-game play statistics for the play session, such as total gifts given, gifts given to charity, or any award given to the user by viewers. In different embodiments, the system displays none, part or all of the information of this user feedback display to the viewers of the stream.

In certain embodiments, following the occurrence of the user identification event and any modifications to any components of (or associated with) the streaming device, one or more components of the system of the present disclosure monitor for an occurrence of a capture event that potentially results in the generation of content to be streamed to one or more viewers at one or more client devices. In these embodiments, responsive to an occurrence of a capture event, the system captures stream data associated with the gaming session occurring at the streaming device. In certain embodiments, the stream data comprises audio/visual content generated by the streaming device and/or captured by the streaming device. In certain embodiments, the stream data additionally or alternatively comprises streaming device data associated with the gaming session and/or the streaming device, such as, but not limited to, meter data (e.g., money in, money out, money wagered, money won), configuration data (e.g., manufacturer, denomination, paytable data), bonusing data (e.g., progressive win, system bonus win), ticket in/ticket out data, and/or cashless fund transfer data.

In certain embodiments, the system captures the content generated by the streaming device, such as content displayed by one or more display devices of the streaming device, to broadcast to the viewers (with the possible addition of supplemental content). In another such embodiment, the system captures certain content generated by the streaming device, such as content displayed by areas or windows of one or more display devices of the streaming device, to broadcast to the viewers (with the possible addition of supplemental content). In this embodiment, rather than displaying to the viewers all the content which the user at the streaming device sees (which may include external controlled interface content personal to the user or other sensitive content not intended to be broadcasted), the system captures certain content, such as a game play content, and does not capture certain other content.

In certain embodiments, following the capture of stream data, the system determines whether a content modification event has occurred. That is, after obtaining the data associated with the content generated by the streaming device which forms at least part of the stream and prior to enabling any viewers access to that particular captured data of the stream, the system determines whether to one or more events have occurred to augment such content by changing part of the content, removing part of the content and/or adding to the content.

In certain embodiments, the system employs one or more generative artificial intelligence models to determine whether a content modification event has occurred. In certain such embodiments, following an identification of a viewer (or a group of viewers) and accessing certain data associated with the viewer (or group of viewers), an artificial intelligence module receives, analyzes, and correlates captured stream data with data clusters of stream data associated with that viewer (or group of viewers) to determine whether or not to cause a content modification event to occur in association with the identified viewer (or group of viewers). In certain such embodiments, following accessing certain data associated with a particular client device (or group of client devices), an artificial intelligence module receives, analyzes, and correlates captured stream data with data clusters of stream data associated with that client device (or group of client devices) to determine whether or not to cause a content modification event to occur in association with that client device (or group of client devices).

If the system determines that a content modification event occurred, the system modifies the stream data captured from the streaming device. In other words, upon an occurrence of a modification event and prior to enabling any viewers access to that particular captured data of the stream, the system modifies or otherwise alters the data captured from the streaming device to supplement the stream with additional information and/or alternative information (i.e., replacement information). In various embodiments, supplemental content derived from such additional information is added to the stream by overlaying the supplemental content onto a captured frame of a display device of the streaming device and/or separately displaying the supplemental content along with a captured frame of a display device of the streaming device such that the stream includes audio-visual content of the user's gaming session as well as the additional information. In various embodiments, supplemental content derived from such alternative information replaces certain information of the stream.

In certain embodiments, the additional information and/or alternative information utilized to form the supplemental content which modifies the stream includes one or more of: still images (e.g., a photograph of a user's reaction during a play of a game), video clips (e.g., a video of a user's reaction to a play of a game), sound clips (e.g., a user's verbal reaction to a play of a game), augmented still images (e.g., an augmented photograph of a user's reaction during a play of the game, such as the user's reaction modified via one or more filters or superimposed with an outcome of a play of the game), augmented video clips (e.g., an augmented video recording of a user's reaction to a play of a game), augmented sound clips (e.g., a user's augmented verbal reaction to a play of a game), audio-video clips, text, non-wagering transaction information associated with the user (e.g., an amount spent purchasing goods at a gaming establishment's luxury clothing store), location information, application usage information, event attendance information, and/or biometric information. In certain embodiments, the system informs the user of the publication of this additional information and/or alternative information. In certain of such embodiments, the system enables the user to opt-out of (or alternatively opt-into) this feature as well as enables the user to configure notifications of when such additional information and/or alternative information is to be published.

In certain embodiments, the system employs one or more generative artificial intelligence models to determine the additional information and/or alternative information which modifies part or all of the stream. In certain such embodiments, following an identification of a viewer (or a group of viewers) and accessing certain data associated with the viewer (or group of viewers), an artificial intelligence module receives, analyzes, and correlates captured stream data with data clusters of stream data associated with that viewer (or group of viewers) to determine the additional information and/or alternative information employed to modify the stream for the identified viewer (or group of viewers). In certain such embodiments, following accessing certain data associated with a particular client device (or group of client devices), an artificial intelligence module receives, analyzes, and correlates captured stream data with data clusters of stream data associated with that client device (or group of client devices) to determine the additional information and/or alternative information employed to modify the stream for that client device (or group of client devices).

In another embodiment, the additional information utilized to form the supplemental content added to the stream includes details about the user's current (or historical) gaming session, such as, but not limited to, a largest award amount won in the gaming session, a duration of the gaming session, an average amount wagered for the gaming session, a total amount wagered for the gaming session, a total amount won for the gaming session, an average amount won for the gaming session, and/or any jackpots won for the gaming session.

In another embodiment, the additional information utilized to form the supplemental content added to the stream includes details about one or more tournaments the user is currently participating in (or historically participated in). In this embodiment, multiple users participate in a gaming establishment tournament where users compete to determine who will win the tournament and one or more users in the tournament stream their play live using the streaming platform of the present disclosure. For example, the system offers a tournament to eligible viewers (e.g., viewers that pay a fee or have a relationship with the user of a streaming device) in which wagers are placed by client devices over a period of time and the client device with the largest win at the end of the period is the winner of the tournament. In such a configuration, the streaming platform is linked to the system running the tournament and tracking the score of the streaming devices that are participating. For example, the live streaming platform uses the data published by the tournament system, such as a tournament manager server (e.g., a component of a tournament management system 122 in communication with the streaming device of FIG. 1A), to display additional information regarding any streamed tournaments (e.g., tournaments 124 offered in association with the live streaming platform of FIGS. 1A to 1C). Such additional information includes, but is not limited to, a current leaderboard of the tournament, a current standing in the tournament (i.e., the user's current position on the leaderboard of the tournament), a largest award amount won in the tournament, a duration of the tournament, an average amount wagered in the tournament, a total amount wagered in the tournament, a total amount won in the tournament, an average amount won in the tournament, and/or any jackpots won in the tournament.

In another embodiment, the additional information utilized to form the supplemental content added to the stream includes details about any achievements earned or otherwise associated with the user and/or the user's current (or historical) gaming session. In this embodiment, the system utilizes game outcome data published by the streaming device to the streaming platform to associate the user of the streaming device (and/or the user of the client device) with one or more achievements such as badges, avatars, access to one or more emojis, awards (in the form of monetary credits, non-monetary credits, physical goods, and/or any award of the present disclosure). The system causes information about such achievements (e.g., achievements 126 maintained in association with the live streaming platform of FIGS. 1A to 1C) to be overlaid onto or displayed along with the captured frames. In different embodiments, such achievements are earned or otherwise associated with the user based on the historical play statistics of the user and/or the historical play statistics of the user relative to the historical play statistics of one or more other users (to determine how each user has relatively performed during one or more gaming sessions). It should be appreciated that while such achievements may be based on game outcome data of a wager amount and any awards, game outcome data may additionally be based on any trackable event occurring in association with a play of a game (e.g., for a play of poker game, the game outcome data includes the hand of playing cards initially dealt, the playing cards held by the user, the final hand of playing cards and any associated award), or occurring independent of any play of any game but otherwise associated with the user's gaming session.

In another embodiment, the additional information utilized to form the supplemental content added to the stream includes details about a quantity of viewers currently viewing the user's gaming session. In another such embodiment, the additional information includes historical details about a quantity of historical viewers whom have viewed the user's historic gaming sessions. In another embodiment, the additional information utilized to form the supplemental content added to the stream includes details about a quantity of views of the user's gaming session. In another such embodiment, the additional information includes historical details about a quantity of historical views of the user's historic gaming sessions. In another embodiment, the additional information utilized to form the supplemental content added to the stream includes details about a quantity of viewers following the user (i.e., a number of followers of the user). In another embodiment, the additional information utilized to form the supplemental content added to the stream includes details about a quantity of subscribers associated with the user.

In another embodiment, the additional information utilized to form the supplemental content added to the stream includes details about any gifts or awards sent to the user of the streaming device by one or more viewers of one or more client devices. In this embodiment, viewers can send monetary gifts to users as a virtual “thank you” for playing well, or performing some action requested by a viewer, wherein the system displays such gifts (either individually or collectively) such that the viewers see the stream of the user's gaming session as well as information regarding such gifts. It should be appreciated that these gifts are funded by electronic credits that viewers establish with the streaming platform. That is, as seen in FIG. 1A to 1C, the system of the present disclosure utilizes accounts associated with viewers 128 that are maintained by one or more components of the live streaming platform and/or one or more components independent of but associated with the live streaming platform. The system employs such accounts to transfer funds to one or more digital accounts or electronic wallets (e.g., gaming establishment account 130 of FIG. 1A) and/or to one or more components of a gaming establishment fund management system that maintain one or more gaming establishment accounts, such as cashless wagering accounts, associated with such users. In different embodiments, such funds are transferred from an account associated with the viewer to an account associated with the user, from an account associated with the viewer to a cashless wagering account maintained for the user by a cashless wagering system of a gaming establishment, and/or from an account associated with the viewer to a credit balance of the streaming device (wherein such transfers are recorded using existing wagering account transfer or bonus meters tracked by a streaming device, or view additional meters added to track such transfers). In another embodiment, such funds are transferred from an account associated with a viewer to the streaming device wherein rather than such funds directly modifying a credit balance of the streaming device, such funds contribute to one or more game outcomes determined by the streaming device (e.g., a gift of $10 from a viewer is provided to the user at the streaming device as an award of $10 associated with a game outcome determined in association with a play of a game). It should be appreciated that any suitable digital wallet or account which maintains or is otherwise associated with an amount of funds for a user at a streaming device and/or a viewer may be utilized in association with the present disclosure.

In another embodiment, the additional information utilized to form the supplemental content added to the stream includes details about any gifts provided to any charities associated with the user of the streaming device by one or more viewers at one or more client devices. In this embodiment, viewers can send monetary gifts to a charity of the user's choosing as a virtual “thank you” for playing well, or performing some action requested by a viewer, wherein the system displays such charitable gifts (either individually or collectively) such that the viewers see the stream of the user's gaming session as well as information regarding such gifts. It should be appreciated that the charitable gift given by a viewer is funded by transferring money from an account that viewer established with the streaming platform to one or more financial institution accounts associated with the charity and maintained by one or more financial institutions.

In another embodiment, the additional information utilized to form the supplemental content added to the stream includes advertising data associated with a gaming establishment (e.g., where the streaming device is located) and/or a third party. For example, as seen in FIGS. 1A to 1C, the streaming device broadcasting the user's video stream operates with the live streaming platform 106 to encode an advertisement 132 for a gaming establishment in the video. For example, the gaming establishment advertisement includes an embedded audio/video clip, such as footage of the user at the streaming device or a promotional audio/video clip of a show attended by the user at a gaming establishment, along with attendance information regarding a user attending the show, the gaming establishment where the concert occurred and advertising text describing upcoming dates for the show. In these embodiments, the gaming establishment advertisement (and/or third party advertisement associated with the stream) offers the viewers different benefits, such as awards, discounts, free points, free promotional credits at the gaming establishment for signing up for a visit to the gaming establishment, for viewing the stream or associating the viewer's player tracking account with their viewer account. In different embodiments, different levels of activity by the viewers are associated with different benefits, wherein the benefit provided to the viewer is based on how much they watch, how many gifts they give users, or how many bets they place. In these embodiments, such benefits are funded by a gaming establishment if the gaming establishment that is hosting the user gets a percentage of the subscriptions to a user's channel, gifts, and/or bets (or a percentage of the hold associated with such bets).

In another embodiment, the additional information utilized to form the supplemental content added to the stream includes details about an additional wager placed by the user at the streaming device. In one such embodiment, the streaming device enables users to place wagers on sporting events while at the streaming device, wherein the information regarding such sports wagers is broadcast as part of their stream. In this embodiment, as the events associated with a sports wager made occur or finalize, the results of the sports wager are reported to the streaming platform by the streaming device (or the sports betting system which maintains and tracks such wagers). Such reporting enables the streaming platform to update the appropriate user statistics and possibly award the user any achievements as described above.

It should be appreciated that any of the additional information and/or alternative information utilized to form the supplemental content may qualify as one or more input of the generative artificial intelligence models used to determine whether a content modification event has occurred and/or any modifications to make to the captured data. In addition to utilizing any of this additional information, in determining whether a content modification event has occurred and/or any modifications to make to the captured data for a particular user, the generative artificial intelligence model employs information regarding a device being used by that user, one or more attributes or preferences of that user (e.g. a status of that user in a patron management system), one or more actions (or inactions) of that user, historical activity of that user (including historical wagering activity, historical gaming activity and/or historical non-wagering and non-gaming activity), any subscriptions of that user (e.g., indicating which games they are interested in), any available assets (e.g., audio, symbols, themes available to user), any game event information to be streamed, a number of users subscribed to or otherwise viewing a game and/or an event, any eligibility criteria, any response to prior events and/or modifications of such prior events (i.e., a feedback loop verification), and/or one or more actions (or inactions) of another user (including wagering activity of the other user).

In certain embodiments, in addition to or alternatively from modifying the stream data captured from the streaming device with additional information and/or alternative information, the modification of the stream data includes removing certain of the captured stream data or otherwise altering the captured stream data. In these embodiments, rather than displaying to the viewers all the content which the user at the streaming device sees (which may include external controlled interface content personal to the user or other sensitive content not intended to be broadcasted), the system obscures certain content prior to being broadcasted to any viewers. For example, if a streaming device is currently displaying a live video stream associated with a sporting event in a window of a display device of the streaming device and the streaming platform lacks the content licenses to also display the live video stream of the sporting event, the system blacks out, grays out or otherwise masks the live video stream of the sporting event from being displayed to viewers.

Following the modification of the data captured from the streaming device or if the system determines that a content modification event did not occur, the system uploads the stream data to the streaming platform. In certain embodiments, the uploaded stream data comprises unmodified captured stream data (e.g., unmodified audio/visual content generated by the streaming device and/or content captured by the streaming device). In certain additional or alternative embodiments, the uploaded stream data comprises modified captured stream data (e.g., modified audio/visual content generated by the streaming device and/or modified content captured by the streaming device). In certain additional or alternative embodiments, the uploaded stream data comprises streaming device data associated with the gaming session and/or the streaming device. In one example in which the streaming device is an EGM, as seen in FIG. 1A, the live streaming platform manager 104 associated with the EGM uploads certain of the live stream data to a video stream infrastructure component 140 of the live streaming platform 106.

In another example in which the streaming device is a SMIB associated with an EGM, as seen in FIG. 1B, a live streaming application 154 being executed by the SMIB uploads certain of the live stream data to the video stream infrastructure component 140 of the live streaming platform 106. In certain embodiments in which the streaming device comprises a component of a gaming establishment management system, such as a SMIB associated with an EGM, to enable the streaming SMIB to capture stream data from the EGM and communicate the stream data to one or more components of the streaming platform, the streaming SMIB comprises various hardware and/or software interfaces. In certain embodiments, the streaming SMIB includes zero, one or more video inputs with hardware interfaces (e.g., HDMI, DVI, VGA or Ethernet), zero, one or more audio inputs (e.g., 3.5 mm analog input or a fiber optic input) and zero, one or more communication interfaces (e.g., serial, Ethernet, fiber or wireless) with the EGM. In certain embodiments, the streaming SMIB includes zero, one or more connections to one or more servers of the live streaming platform and/or one or more servers of the gaming establishment management system. In these embodiments, as seen in FIG. 1B, the streaming SMIB operates with a video capture device 152 to encode video data outputted by the EGM into one or more video formats for streaming and communicate that video data to one or more video stream infrastructure components 140 of the live streaming platform 106.

In another example in which the streaming device is a personal gaming device operating with a remote game server, as seen in FIG. 1C, a video capture component 178 of the personal gaming device 172 uploads certain of the live stream data to the video stream infrastructure component 140 of the live streaming platform 106. In certain embodiments in which the streaming device comprises a personal gaming device 172 operating with a remote game server 170 and a remote gaming platform 174 that maintains one or more user accounts and operates with the remote game server to enable wagering of plays of games with funds held in such maintained user accounts, to enable the capturing of live stream data and communication of the live stream data to one or more components of the live streaming platform, a video capture component 178 associated with the personal gaming device interfaces with zero, one or more peripheral devices (e.g., camera 118 and headset audio interface 120) to capture certain data of the live stream. In these embodiments, the streaming personal gaming device (operating with the video capture component and employing certain data communicated from the remote game server and/or the remote gaming platform) encode video data outputted by the personal gaming device into one or more video formats for streaming and communicate that video data to one or more video stream infrastructure components 140 of the live streaming platform 106.

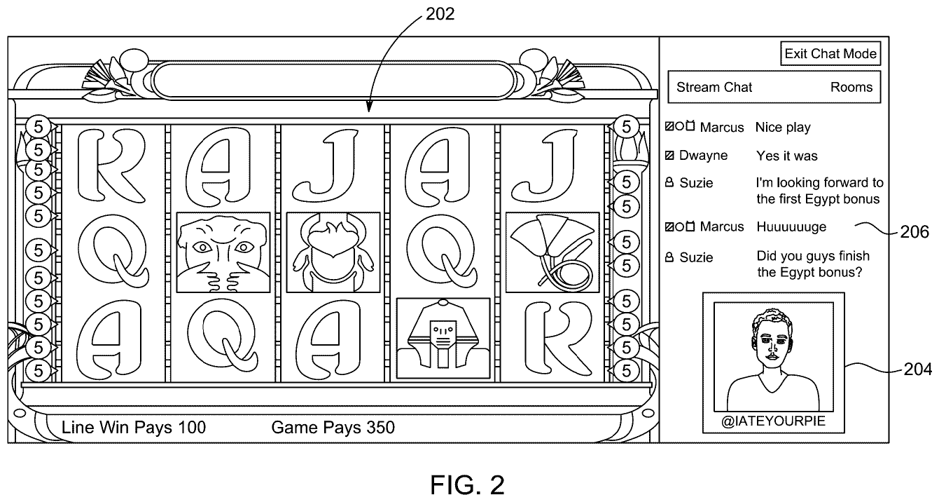

Following the upload of streaming data, the streaming platform enables one or more viewers at one or more client devices to access the stream data. In certain embodiments, the streaming platform enables viewers at the client devices to view the stream and, in certain instances, interact with the streaming device. For example, as seen in FIGS. 1A to 1C, the live streaming platform 106 enables viewers at different client devices (e.g., a mobile client device 108a, a personal client device 108b and an EGM operating as a client device 108c) to view the live stream (including, but not limited to, as seen in FIG. 2, viewing a play of a game 202 and audio/video content of the user at the streaming device 204) and, in certain instances, interacting with the streaming device (including, but not limited to, as also seen in FIG. 2, chatting with the user at the streaming device 206 in one or more chat windows or chat rooms).

In certain embodiments, the streaming platform enables any viewer to access any stream associated with any streaming device. In certain embodiments, the streaming platform restricts certain viewers from accessing certain streams associated with certain streaming devices. In certain embodiments, the system restricts access to certain streams based on one or more of an age of the viewer, a ranking of the viewer (e.g., a player tracking status of the viewer), a subscription of the viewer (e.g., has the viewer subscribed to the user of the streaming device and/or the streaming device), a location of the viewer, any invitation to participate extended to the viewer, an age of the user, a location of the user, a ranking of the user (e.g., a player tracking status of the user), any invitation to participate extended to the user, any regulations pertaining to the age and/or location of the viewer, and/or any regulations pertaining to the age and/or location of the user.

It should be appreciated that in certain embodiments in which the system employs one or more generative artificial intelligence models to determine additional information and/or alternative information which will modify the stream, different users access different streams that are based on the same events occurring at the same streaming device. That is, the generative artificial intelligence model personalizes the streams different users may access based on one or more inputs, such as user preferences, user histories, user backgrounds and/or the state of one or more devices. For example, if the content of the streamed game from the streaming device is a pirate theme with a male character, the generative artificial intelligence model modifies the stream using a female character's voice and image for certain users the generative artificial intelligence model determines prefer the female character. Accordingly, in certain embodiments, the system monitors the stream and uses one or more artificial intelligence predictive models to generate correlations between the content of the stream and one or more content data clusters. The system then determines, based at least in part on the correlations, whether to modify any content of the stream for one or more users and if so, one or more parameters of such modified content. Such a generative-model-enabled content modification system operates to offer unique content to a single user (i.e., personalized content) and/or a group of users (i.e., targeted audience content) in a unique way so that it is increasingly appealing to users by employing a single game event at least partially originating with a streaming device and using generative artificial intelligence to change part of how that single game event is presented to create multiple different streams to different respective users.

In certain embodiments which impose one or more restrictions on viewers, the system enables a viewer to pay a fee (e.g., a daily fee, weekly fee, monthly fee or yearly fee) to view one or more streams and/or participate in one or more chats. In one such embodiment, if the system requires a viewer to pay to fully participate in the live stream, then in addition to any percentage of the fees allocated to the operator of the live streaming platform (e.g., the component associated with the gaming establishment operator 134 of FIGS. 1A to 1C), the system allocates a percentage of the fee to the user at the streaming device associated with the live stream. In another such embodiment, if the system requires a viewer to pay to fully participate in the stream, then in addition to any percentage of the fees allocated to the operator of the streaming platform, the system additionally or alternatively allocates a percentage of the fee to the gaming establishment where the streaming device associated with the stream is at. In this embodiment, if the streams associated with a user occurred via the user playing multiple streaming devices at multiple gaming establishments, the system splits the fees amongst the multiple gaming establishments based on any suitable fee splitting arrangement, such as based on hours played at each streaming device and/or coin-in at each streaming device.

In certain embodiments, the streaming platform enables one or more viewers interfacing with a client device to access the stream without further interactions. In these embodiments, the streaming platform enables the viewer to passively observe the events occurring at the streaming device. In certain embodiments, the streaming platform enables one or more viewers interfacing with a client device to access the stream and further interact with (and/or employs an artificial intelligence predictive model to interact with) the user at the streaming device. In these embodiments, the additional information utilized to form the supplemental content includes the interactions between the different users of the different devices in the streaming environment. For example, live streaming platform interface 116 enables one or more chats (i.e., interactions) to occur between the streaming device and zero, one or more client devices utilizing a chat component 142 of the live streaming platform 106 of FIGS. 1A to 1C. In these embodiments, upon an occurrence of a viewer interaction event, the streaming platform enables the viewer to not only observe the events occurring at the streaming device but additionally interact with (and/or employs an artificial intelligence predictive model to interact with) the user at the streaming device, such as by providing gifts to the user at the streaming device and/or participating in a conversation with the user at the streaming device. In certain embodiments, the streaming platform enables one or more viewers interfacing with a client device to access the stream and further interact with (and/or employs an artificial intelligence predictive model to interact with) the streaming platform to access certain wagering features. In these embodiments, upon an occurrence of a viewer interaction event, the streaming platform enables the viewer to not only observe the events occurring at the streaming device from the client device but additionally interact with the streaming platform from the client device to place one or more wagers on one or more events occurring at the streaming device which are part of the stream.

In one embodiment wherein the viewer interfacing with a client device actively interacts with the stream, following the viewer establishing and adequately funding a streaming wagering account (e.g., account 128 maintained in association with the live streaming platform of FIGS. 1A to 1C) and accessing a stream associated with a gaming session at a streaming device, the streaming platform enables the viewer to place a bet (e.g., back betting opportunities 136 offered in association with the live streaming platform of FIGS. 1A to 1C). In certain embodiments, such bets are based on the bet placed by the user at the streaming device and may be associated with a play of a game (e.g., the game 138 offered by the EGM operating as the streaming device of FIG. 1A) occurring at the streaming device and/or any wagerable event occurring at the streaming device that is independent of any play of any game. In this embodiment, if the user at the streaming device does not win any award based on the placed wager, then the viewer also loses the bet. On the other hand, if the user at the streaming device wins an award (having a value greater than zero) based on the placed wager, then any viewer who was betting along with the user at the streaming device will win the same amount. In one such embodiment, the system provides the entire win amount of the viewer to the viewer (to place another bet or transfer to the streaming wagering account). In another such embodiment, the system provides or otherwise automatically gifts a portion of the win amount of the viewer to the user at the streaming device.

In another embodiment wherein the viewer interfacing with a client device actively interacts with the stream, following the viewer establishing and adequately funding a streaming wagering account and accessing a stream associated with a gaming session at a streaming device, the streaming platform enables the viewer at the client device to place a bet on a play of a game or other event occurring at the streaming device independent of any bet placed by the user at the streaming device. In this embodiment, the system enables a wager to be placed by the viewer at the client device on any suitable event that may or may not occur in association with one or more plays of one or more games at the streaming device and/or independent of any such plays at the streaming device. That is, the streaming platform enables the viewer at the client device to wager on different events occurring in association with the streaming device, such as, but not limited to, the type of wins occurring at the streaming device, the amount of wins/losses occurring at the streaming device, any changing in a credit meter of the streaming device, any bonus being hit or other game event to be trigger at the streaming device including the number of times the event happened. For example, the streaming platform enables the viewer at the client device to place a wager that a progressive award will be won in the next one-hundred games played at the streaming device, during a session of gaming at the streaming device, over a period of time (e.g., thirty minutes) of gaming at the streaming device, and/or during a time window (e.g. 1:00 pm until 1:30 pm) of gaming at the streaming device. In different embodiments, the system provides the entire win amount of any winning wager of the viewer to the viewer (to place another bet or transfer to the streaming wagering account) or the system provides a portion of the win amount of any winning wager to the viewer to the viewer, such as by automatically gifting a portion of the win amount of the viewer to the user at the streaming device.

In another embodiment wherein the viewer interfacing with a client device actively interacts with the stream, following the viewer establishing and adequately funding a streaming wagering account and accessing a stream associated with a gaming session at a streaming device, the streaming platform enables the viewer to place a bet against one or more other viewers (and/or one or more users at one or more streaming devices). For example, the system enables a viewer to place a bet on which user will win an ongoing tournament. In this embodiment, if the wagered on user does not win the ongoing tournament, then the viewer loses their wager. On the other hand, if the wagered on user wins the ongoing tournament, then the system provides the viewer an award based on the lost wagers placed by one or more other viewer (and/or one or more users at one or more streaming devices) minus a percentage held by the system.

In certain embodiments, the system employs one or more generative artificial intelligence models to determine one or more wagers available to be placed by one or more users interacting with the streaming platform. In certain such embodiments, following an identification of a viewer (or a group of viewers) and accessing certain data associated with the viewer (or group of viewers), an artificial intelligence module receives, analyzes, and correlates data associated with one or more events of the stream with data clusters of wagering data associated with that viewer (or group of viewers) to determine whether a wagering opportunity event occurred in association with that viewer (or group of viewers) and/or one or more parameters of an available wagering opportunity unique to that viewer (or group of viewers). In these embodiments, the system uses the generative artificial intelligence model to determine whether or not to offer a viewer an additional and/or alternative betting opportunity that is customized to that particular viewer, such as based on prior wagering activity of that viewer. In certain such embodiments, following accessing certain data associated with a particular client device (or group of client devices), an artificial intelligence module receives, analyzes, and correlates data associated with one or more events of the stream with data clusters of wagering data associated with that client device (or group of client devices) to determine whether a wagering opportunity event occurred in association with that client device (or group of client devices) and/or one or more parameters of an available wagering opportunity unique to that client device (or group of client devices). In operation of different embodiments, in real-time (and, in certain instances, at static intervals) one or more events occurring (or scheduled to occur) in association with a streaming device are quantified and transferred to an artificial intelligence server upon which a generative artificial intelligence model is loaded. In these embodiments, the generative artificial intelligence model, operating with one or more random number generators, generates one or more bet options and sends the generated bet options to one or more client devices that enable users of such client devices to place one or more bets.

In certain embodiments in which the system employs one or more generative artificial intelligence models to determine whether a wagering opportunity event occurred and/or one or more parameters of an available wagering opportunity, different users are offered different wagering opportunities that are based on the same events occurring at the same streaming device. That is, the generative artificial intelligence model personalizes the wagering opportunities to different users based on one or more inputs, such as user preferences, user histories, user backgrounds and/or the state of one or more devices For example, a recipient of a real-time stream at a client device is offered the opportunity to place a personalized wager on certain events (e.g., a user is offered an opportunity to bet $1 that a jackpot will be triggered in the next 30 mins). In this example, the system customizes the wagering opportunities based on information associated with the user (e.g., the system alerts the user that they recently won $40 based on predicting how soon a jackpot would hit during a streaming session and offers the user another opportunity to place a similar wager regarding how soon a jackpot will hit during a current streaming session). Accordingly, in certain embodiments, the system monitors the stream and uses one or more artificial intelligence predictive models to generate correlations between events of the stream and one or more wagering opportunity data clusters. The system then determines, based at least in part on the correlations, whether to offer any personalized wagering opportunities for one or more users and if so, one or more parameters of such personalized wagering opportunities. In such embodiments, the system utilizes one or more artificial intelligence predictive models (such as, but not limited to, convolutional collaborative filter networks, artificial neural networks, supervised machine learning models and/or unsupervised machine learning models) to determine different wagering opportunities to make available to different users to customize the gaming experience of these different users. As such, the generative-model-enabled wagering system of these embodiments operates to offer unique wagering options to a single user (i.e., personalized wagering) and/or a group of users (i.e., targeted audience wagering) in a unique way so that it is increasingly appealing to users.

In different embodiments, the system of the present disclosure is configured to enable the play of any suitable game, such as a wagering game, a non-wagering casual game, and/or a non-wagering social game, occurring at a streaming device to be streamed to one or more viewers at one or more client devices. In certain embodiments, the game comprises a play of a primary game, such as a primary wagering game, wherein the game triggering event includes the placement of a wager on the play of the primary game. In certain embodiments, the game comprises a play of a secondary game, such as a free spin game, wherein the game triggering event occurs based on a displayed event associated with a play of a wagered on primary game. In certain embodiments wherein the game comprises a secondary game, such as a free spin game, the game triggering event occurs based on an event independent of any displayed event associated with the play of the wagered on primary game. In various embodiments, the displayed play of the wagering game, the non-wagering casual game, and/or the non-wagering social game includes, but is not limited to: a play of any suitable spinning reels game, a play of any suitable wheel game; a play of any suitable card game such as blackjack, poker or baccarat; a play of any suitable keno game; a play of any suitable bingo game; a play of any suitable offer and acceptance game; a play of any suitable award ladder game; a play of any suitable puzzle-type game; a play of any suitable persistence game; a play of any suitable selection game; a play of any suitable cascading symbols game; a play of any suitable ways to win game; a play of any suitable scatter pay game; a play of any suitable coin-pusher game; a play of any suitable elimination game; a play of any suitable stacked wilds game; a play of any suitable trail game; a play of any suitable bingo game; a play of any suitable video scratch-off game; a play of any suitable pick-until-complete game; a play of any suitable shooting simulation game; a play of any suitable racing game; a play of any suitable promotional game; a play of any suitable high-low game; a play of any suitable lottery game; a play of any suitable number selection game; a play of any suitable dice game; a play of any suitable skill game; a play of any suitable partial skill game; a play of any suitable auction game; a play of any suitable reverse-auction game; a play of any suitable group game; and/or a play of any other game of the present disclosure. In certain embodiments, the awards available to be won by one or more viewers of one or more client devices in association with one or more wagers placed by such viewers of such client devices (as well as the awards available to the user of the streaming device) include, but are not limited to, one or more of: a quantity of monetary credits, a quantity of non-monetary credits, a quantity of promotional credits, a quantity of player tracking points, a progressive award, a modifier, such as a multiplier, a quantity of free plays of one or more games, a quantity of plays of one or more secondary or bonus games, a multiplier of a quantity of free plays of a game, one or more lottery based awards, such as lottery or drawing tickets, a wager match for one or more plays of one or more games, an increase in the average expected payback percentage for one or more plays of one or more games, one or more comps, such as a free dinner, a free night's stay at a hotel, a high value product such as a free car, or a low value product, one or more bonus credits usable for online play, a lump sum of player tracking points or credits, a multiplier for player tracking points or credits, an increase in a membership or player tracking level, one or more coupons or promotions usable within and/or outside of the gaming establishment (e.g., a 20% off coupon for use at a convenience store), virtual goods associated with the system, virtual goods not associated with the system, an access code usable to unlock content on an internet.

It should be appreciated that in certain embodiments which enable one or more viewers of one or more client devices to interact with one or more streams (e.g., via chatting with a user at the streaming device generating at least part of the stream and/or via wagering on one or more events associated with the streaming device generating at least part of the stream), the streaming platform accounts for this interaction in determining any additional information and/or alternative information to display as part of the stream. For example, the additional information incorporated as part of a stream includes data associated with one or more bets placed in association with a user at a streaming device, such as the amount won by viewers for betting on a user at a streaming device or the win and loss records for betting sports wagers placed by viewers in association with a user at a streaming device. In such embodiments wherein one or more viewers interact with the stream, since the streaming device is the entity that encodes the video stream, any activities or event occurring on the streaming platform must be sent to the streaming device to update any graphical elements rendered in the video stream. For example, if a viewer sends a gift to a user at the streaming device, then the streaming platform generates an award message. In this example, either the streaming platform sends the generated message to the streaming device, or the streaming device actively polls the streaming platform for any outstanding notification messages. Upon receipt of a notification message, the streaming device acts upon the notification, such as displaying a notification that only the user at the streaming device can see, rendering of one or more notifications onto the game itself, and/or rendering of one or more notifications as part of the video stream (which are viewable by viewers and may or may not be seen by the user at the streaming device).

In various embodiments, the systems of the present disclosure additionally or alternatively communicate one or more notifications to one or more potential users of one or more devices in association with an opportunity to view and/or wager on plays of games occurring at a streaming device. In these embodiments, the notifications take the form of one or more targeted messages to different users that are sent responsive to different events occurring in association with a streaming environment.

In certain embodiments, the system interacts with a client device to cause the client device to provide one or more notifications regarding an event that has occurred (or will potentially occur) in association with the streaming platform. In these embodiments, the recipient of the notification is already engaging a client device and the system operates to convey information to the user of the client device regarding additional offerings of the streaming platform. For example, following a determination that a particular user of a streaming device has enabled wagering on plays of games occurring during a streaming session at the streaming device, the system causes one or more notifications regarding the wagering opportunities of the streaming session to be communicated to one or more users of one or more client devices that may want to participate in such wagering opportunities and/or interact with the user of the streaming device. In this example, the notification enables the user of the client device to make one or more inputs to participate in the streaming session that caused the notification to be communicated. In these embodiments, the notification to the user of the client device includes any suitable message and/or animation displayed by the client device, any suitable sound generated by the client device and/or any suitable vibration of the client device that operate to make the user of the client device aware of the event occurring (or event anticipated to occur) in association with the streaming platform. Accordingly, the system of the present disclosures determines different content to communicate to different users of client devices to make such users aware of the happenings occurring at one or more streaming devices which such users may have a particular interest in. Such a configuration enables users to stay abreast of developments in the streaming platform and not miss out of opportunities that occur in the streaming platform, such as opportunities to place wagers and win awards.

In certain embodiments, the system interacts with a device not currently operating as a client device, such as a mobile device not currently receiving any data associated with any games being streamed from the streaming platform, to cause that device to provide one or more notifications regarding an event that has occurred (or will potentially occur) in association with the streaming platform. In these embodiments, the recipient of the notification is not yet engaging a client device (or is engaging a client device, such as a mobile client device, for activities independent of the streaming platform) and the system operates to convey information to this potential user of the device regarding additional offerings of the streaming platform. For example, following a determination that a progressive award is relatively close to a must-hit by amount and/or a streaming session is available to be initiated from a new streaming device, the system causes one or more notifications to be communicated to one or more users of one or more devices that may be interested in such developments. In these embodiments, the notification to the potential user includes any suitable message and/or animation displayed by the device, any suitable sound generated by the device and/or any suitable vibration of the device that operate to make the user of the device aware of the event occurring (or event anticipated to occur) in association with the streaming platform. Accordingly, the system of the present disclosures determines different content to communicate to different potential users to make such potential users aware of the happenings occurring at one or more streaming devices which such potential users may have a particular interest in. Such a configuration enables users to stay abreast of developments in the streaming platform and not miss out of opportunities that occur in the streaming platform, such as opportunities to place wagers and win awards, when such users are not currently engaging a client device currently operating with the streaming platform.

In certain embodiments, the system employs one or more generative artificial intelligence models to determine one or more notifications communicated to one or more users interacting with (or potentially interacting with) the streaming platform. In certain such embodiments, following an identification of a viewer (or a group of viewers) and accessing certain data associated with the viewer (or group of viewers), an artificial intelligence module receives, analyzes, and correlates data associated with one or more events of the stream with notification data clusters associated with that viewer (or group of viewers) to determine whether a notification event occurred in association with that viewer (or group of viewers) and/or one or more parameters of the content of a notification unique to that viewer (or group of viewers). In these embodiments, the system uses the generative artificial intelligence model to determine whether or not to provide a viewer any notifications customized to that particular viewer, such as based on prior alerts communicated to that viewer. In certain such embodiments, following accessing certain data associated with a particular client device (or group of client devices), an artificial intelligence module receives, analyzes, and correlates data associated with one or more events of the stream with notification data clusters associated with that client device (or group of client devices) to determine whether a notification occurs in association with that client device (or group of client devices) and/or one or more parameters of the content of a notification unique to that client device (or group of client devices).

It should be appreciated that by employing one or more generative artificial intelligence models to determine one or more notifications communicated to one or more users interacting with (or potentially interacting with) the streaming platform, different notifications are conveyed to different users based on the same events occurring (or not occurring) at the same streaming device. That is, the generative artificial intelligence model personalizes the notifications provided to different users based on one or more inputs, such as user preferences, user histories, user backgrounds and/or the state of one or more devices For example, the system matches the notification to certain user data (e.g., user selected preferences of notifications of interest) such that the generated notification is context relevant and appropriate giving the user a feeling of nativeness in interacting with the system. Accordingly, in certain embodiments, the system monitors the stream and uses one or more artificial intelligence predictive models to generate correlations between events of the stream and one or more notification data clusters. The system then determines, based at least in part on the correlations, whether to offer any personalized notifications for one or more users and if so, one or more parameters of such personalized notifications. In such embodiments, the system utilizes one or more artificial intelligence predictive models (such as, but not limited to, convolutional collaborative filter networks, artificial neural networks, supervised machine learning models and/or unsupervised machine learning models) to determine different notifications to convey to different users to customize the gaming experience of these different users. As such, the generative-model-enabled notification system operates to adjust the notifications to a single user (i.e., personalized notifications) and/or a group of users (i.e., targeted audience notifications) in a unique way so that it is increasingly appealing to users. Such a configuration enables users to stay abreast of developments in the streaming platform and not miss out of opportunities that occur in the streaming platform, such as opportunities to place wagers and win awards.

In certain embodiments that utilize one or more generative artificial intelligence models to determine one or more notifications, the generated content of such notifications is targeting to groups of users sharing similar interests and behaviors. In certain such embodiments, the system employs behavioral analysis and clustering to generate groups of comparable play behaviors such that the system targets these groups with the same content (e.g., random chances of gambling events). In certain embodiments, certain eligible users (e.g., heavy use players) additionally or alternatively qualify for exclusive personalized and tailored content that would not be made available to other users.

In certain embodiments, prior to determining to convey any notifications to any users (upon an occurrence of a notification event), the system determines which users are eligible to receive notifications regarding events occurring (or potentially occurring) in association with the streaming platform. In certain such embodiments, eligibility to receive notifications associated with a streaming session is based on one or more actions (and/or inactions) of a user (and/or other users) occurring in the streaming environment. In these embodiments, different actions (and/or inactions) undertaken by a potential user remote from any client device, a user at a client device and/or a user at the streaming device factor into whether or not notifications are available to be communicated.

In certain additional or alternative embodiments, the eligibility of a user to receive notifications associated with a streaming session is based on the device being used by the user. In these embodiments, different devices have different settings and/or capabilities that determine whether or not a user at that device is eligible to receive one or more notifications.

In certain additional or alternative embodiments, the eligibility of a user to receive notifications associated with a streaming session is based on one or more attributes or preferences of the user. In certain embodiments, the system associates different users with different eligibilities to receive notifications. In certain embodiments, the system associates different users with different priorities of when they receive notifications (e.g., users at or above a certain ranking or status receive notifications before users below that ranking or status). In certain instances, the notification eligibility and/or the priority order to receive notifications associated with a user is based on one or more of whether or not the user has an account with a gaming establishment management system (e.g., a player tracking account maintained by a patron management system), the ranking of any account the user has with the gaming establishment management system (e.g., users of a certain player tracking status, such as gold level and silver level users, are eligible to receive one or more notifications while users of a different player tracking status, such as bronze level users, are ineligible from receiving one or more notifications), whether or not the user has an account maintained by the streaming platform, whether or not any account is configured to enable the placement of wagers in association with one or more streams, a balance of an account maintained by the streaming platform (e.g., users associated with an account having a balance at or above a threshold value are eligible to receive one or more notifications while users associated with an account having a balance below the threshold value are ineligible from receiving one or more notifications), a status of the user in the streaming environment, an age of the user (detectable by a camera of the device of the user and/or an age verification procedure associated with one or more accounts of the user), a location of the user, and/or a random determination (which may or may not be at least partially based on one or more of the above-described attributes or preferences of the user).

In certain additional or alternative embodiments, the eligibility of a user to receive notifications associated with a streaming session is based on one or more actions (or inactions) of the user. In certain embodiments, the notification eligibility to associate with a user is based on one or more user preferences regarding which notifications the user wants to receive (and which notifications the user does not want to receive), user preferences regarding the amount of notifications the user wants to receive, and/or user preferences regarding the frequency of notifications the user wants to receive. In certain embodiments, the eligibility is determined based on one or more inputs received by the user, such as the user making one or more inputs to activate or deactivate receiving one or more notifications and/or changing any of the user preferences. In these embodiments, the system enables a user to manually subscribe to events (e.g., games) they are interested in and want to be updated about in real-time. For example, the system enables a user to interact with a device (and/or employs an artificial intelligence predictive model) to enable (and/or disable) notifications in general as well as configure notifications based on various parameters, such as, but not limited to, an identity of a user at a streaming device, a game type, a wager amount, a game theme, individual gaming session statistics, accumulated gaming session statistics, viewer statistics, and/or client device wagering statistics. In another example, to comply with one or more responsible gaming restrictions selected by the user, the system determines if any responsible gaming thresholds are exceeded and if so, limits (and/or prohibits) notifications (and limits and/or prohibits corresponding wagering opportunities and/or wager amounts) for a defined period of time.

In certain embodiments, the eligibility of a user to receive notifications associated with a streaming session is based on an amount of notifications historically received in association with a user of a streaming device over a period of time. In certain instances, the eligibility associated with a user remote from any client device and/or a user at a client device is based on the amount of and/or content of notifications associated with the user at the streaming device. In these embodiments, different amounts of historical notifications and/or historical content are associated with different levels of eligibility to receive future notifications. In certain additional or alternative embodiments, the eligibility of a user to receive notifications associated with a streaming session is based on an amount of notifications previously communicated to that user. In certain instances, the eligibility associated with the user at (or remote from) the client device is based on the quantity of notifications historically sent to that user and/or the content of the notifications sent to that user. In these embodiments, different quantities of historic notifications and/or different content conveyed in such prior notifications are associated with different levels of eligibility.

In certain additional or alternative embodiments, the eligibility of a user to receive notifications associated with a streaming session is based on another user. For example, a user at a streaming device determines the eligibility of one or more users remote from any client devices and/or users at one or more client devices to receive notifications. In certain embodiments, the eligibility of a user to receive notifications associated with a streaming session is based on an operator of the streaming system. In these embodiments, the operator of the streaming system determines, for one or more users remote from any client devices, one or more users at one or more client devices and/or one or more users at one or more streaming devices, an eligibility to receive notifications. For example, for promotional purposes and/or to reward loyal users, an operator selects which products (e.g., games being streamed) qualify for one or more notifications to be communicated to one or more users.

In certain additional or alternative embodiments, the eligibility of a user to receive notifications associated with a streaming session is based on that user following a user of a streaming device on one or more social media sites. In certain instances, the eligibility associated with the user remote from any client device and/or at the client device is based on the length of time following the user of the streaming device, the quantity of social media activity (e.g., likes or shares of content associated with the user of the streaming device) and/or the quantity of social media sites which the user of the streaming device is being followed on. In these embodiments, different lengths of time, quantities of social media activities and/or quantities of social media sites are associated with different levels of eligibility to receive notifications. In certain additional or alternative embodiments, the eligibility of a user to receive notifications associated with a streaming session is based on that user subscribing to a streaming channel associated with a user of a streaming device. In different embodiments, such a subscription costs an amount of money (which is funded by the account associated with the user at (or remote from) the client device maintained by the streaming platform). In certain instances, the eligibility associated with the user at (or remote from) the client device is based on the amount of money spent subscribing and/or the length of time subscribing. In these embodiments, different amounts of money and/or lengths of time are associated with different levels of eligibility.

In certain additional or alternative embodiments, the eligibility of a user to receive notifications associated with a streaming session is based on an amount of time historically spent viewing the stream originating from a user of a streaming device over a period of time. In different embodiments, such viewing can be of streams and/or recorded streams. In certain instances, the eligibility associated with the user at (or remote from) the client device is based on the length of time historically viewing the content associated with the user at the streaming device and/or which streams are viewed. In these embodiments, different lengths of time and/or streamed content viewed are associated with different levels of eligibility.

In certain additional or alternative embodiments, the eligibility of a user to receive notifications associated with a streaming session is based on one or more placed wagers with (or against) a user of a streaming device over a period of time, such as over a subset of past streaming sessions associated with a period of time or over all past streaming sessions regardless of when they occurred. In certain instances, the eligibility associated with the user at (or remote from) the client device is based on a quantity of wagers made in association with the streamed games from the streaming device and/or an amount of the wagers made in association with the streamed games from the streaming device. In these embodiments, different wager amounts (individually and/or collectively) are associated with different levels of eligibility. In certain additional or alternative embodiments, the eligibility of a user to receive notifications associated with a streaming session is based on one or more outcomes obtained by a user of a streaming device over a period of time. In certain additional or alternative embodiments, the eligibility of a user to receive notifications associated with a streaming session is based on one or more outcomes donated to a user of a streaming device over a period of time. In certain instances, the eligibility associated with the user at (or remote from) the client device is based on amount of the outcomes provided and/or which outcomes are provided in association with the streamed games of the streaming device. In these embodiments, different amounts of outcomes and/or types of outcomes are associated with different levels of eligibility.

In certain additional or alternative embodiments, the eligibility of a user to receive notifications associated with a streaming session is based on one or more amounts of money donated to a user of a streaming device over a period of time. In certain instances, the eligibility associated with the user at (or remote from) the client device is based on amount of money provided and/or the frequency of giving money. In these embodiments, different amounts of money (individually and/or collectively) and/or different frequencies of giving are associated with different levels of eligibility.

In certain embodiments, a user's activity in the streaming environment at least partially determines the eligibility to receive notifications from within that streaming environment. In certain additional or alternative embodiments, a user's activity outside of the streaming environment at least partially determines or otherwise affects the eligibility to receive notifications from within the streaming environment. In certain such embodiments, for a user of a client device that is associated with a land-based gaming establishment account, such as a player tracking account, the streaming platform utilizes the land-based gaming establishment account to at least partially determine or otherwise affect the eligibility to receive notifications.

It should be appreciated that while described as employing one or more factors in determining eligibility of a user at a client device and/or a user remote from a client device, one or more of such factors are additionally or alternatively employed in determining eligibility for a user at a streaming device. For example, eligibility to cause a notification associated with a user at a streaming device is based on one or more placed wagers over a period of time in which different wager amounts (individually and/or collectively) are associated with different levels of eligibility. In another example, eligibility to cause a notification associated with a user at a streaming device is based on one or more outcomes obtained by the user of the streaming device over a period of time in which different outcomes obtained and/or different award amounts (individually and/or collectively) are associated with different levels of eligibility.

It should be further appreciated that any of the above-described factors employed in determining eligibility of a user at a client device and/or a user remote from a client device to receive any notifications may be employed by any of the generative artificial intelligence models in determining whether a notification event occurred, the content of any generated notifications, whether a potential wagering event occurred, one or more parameters of any determined wagering opportunities, whether a content modification event occurred, and/or any modifications to any content. For example, one or more of an action (and/or inaction) of a user, historical actions (and/or historical inactions) of a user, a device being used by a user, and/or an attribute or preference of a user are used as one or more inputs in one or more artificial intelligence models in determining one or more of whether a notification event occurred, the content of any generated notifications, whether a potential wagering event occurred, one or more parameters of any determined wagering opportunities, whether a content modification event occurred, and/or any modifications to any content.

In certain embodiments, in addition to utilizing one or more tracked activities (and/or activities) occurring in association with a user to determine the eligibility to receive notifications, if the system determines that a user is eligible to receive one or more notifications, the system monitors for an occurrence of a notification event that results in one or more notifications being communicated to zero, one or more users determined eligible to receive such notifications.

In certain embodiments, a notification event occurs when a streaming session is initiated. In these embodiments, upon the initiation of a streaming session, the system causes one or more notifications to be communicated to one or more eligible users to make such users aware of the streaming session. In certain embodiments, a notification event occurs when a streaming session is initiated at a certain streaming device. In these embodiments, upon the initiation of a streaming session at that certain streaming device, the system causes one or more notifications to be communicated to one or more eligible users to make such users aware of the streaming session.

In certain embodiments, a notification event occurs when a streaming session is initiated by a certain user at a streaming device. In these embodiments, upon the initiation of a streaming session by that certain user, the system causes one or more notifications to be communicated to one or more eligible users to make such users aware of the streaming session. In certain of these embodiments, the system communicates one or more notifications to a user at a client device and/or a user remote from a client that has a designated relationship with the user that initiated the streaming device (e.g., users that like, follow, are friends with or subscribe to the user of the streaming device, users with an account linked to the user of the streaming device, and/or users that previously engaged with the user of the streaming device, such as by talking, chatting or direct messaging).

In certain embodiments, a notification event occurs when a streaming session is initiated with wagering by one or more users of client devices is enabled. In these embodiments, if back betting from qualifying client devices is enabled, the system causes one or more notifications to be communicated to one or more eligible users to make such users aware of the streaming session (and if such a feature is not enabled, no such notification is communicated). In certain embodiments, a notification event occurs when a streaming session is initiated with wagering enabled for certain users of certain client devices, such as users that previously placed wagers on games being played by the user of the streaming device. In these embodiments, if such a feature is enabled, the system causes one or more notifications to be communicated to one or more eligible users to make such users aware of the streaming session (and if such a feature is not enabled, no such notification is communicated). In certain embodiments, a notification event occurs when an ongoing streaming session enables wagering by one or more users of client devices. In these embodiments, if back betting from qualifying client devices is enabled in association with a streaming session that previously disabled such back betting, the system causes one or more notifications to be communicated to one or more eligible users to make such users aware of the streaming session (and if such a feature remains disabled, no such notification is communicated).

In certain embodiments, a notification event occurs when a streaming session with wagering capabilities by users at client devices is occurring (or about to occur) in association with a certain user at a streaming device. In these embodiments, in association with a streaming session by that certain user, the system causes one or more notifications to be communicated to one or more eligible users to make such users aware of the streaming session and the back betting availability on plays of games of the streaming session. In certain of these embodiments, the system communicates one or more notifications to a user at a client device and/or a user remote from a client that has a designated relationship with the user at the streaming device (e.g., users that like, follow, are friends with or subscribe to the user of the streaming device, users with an account linked to the user of the streaming device, and/or users that previously engaged with the user of the streaming device, such as by talking, chatting or direct messaging).

In certain embodiments, a notification event occurs when a quantity of users have joined a streaming session. In certain embodiments, a notification event occurs when a quantity of users having a designated relationship to each other (e.g., users that like, follow, are friends with each other, and/or users that previously engaged with each other such as by talking, chatting or direct messaging) have joined a streaming session. Such a configuration may entice one user to also join a streaming session so they can interact with their friends or other streamers/influencers that they follow or are associated with.

In additional or alternative embodiments, a notification event occurs in association with one or more events that occurred in the streaming environment, such as, but not limited to, a system event, a user joining or leaving a stream, a client device joining a wagering session, a designated event that occurred at a client device, a beginning of a wagering session, an ending of a wagering session, an ending of a streaming session, a wagering configuration change (e.g., a change in the type of wagers and/or amounts of wagers available to be placed from a client device). In additional or alternative embodiments, a notification event occurs in association with a determination of certain information such as, but not limited to, session information, summary information, statistical information (e.g., there is a 98% chance to win the hand of the current play of the game), interaction information (e.g., a number of notifications has not reached a threshold), streaming device wagering information (e.g., the various wagers placed when a user of a streaming device plays a game) and/or client device wagering information (e.g., the denominations, total wagered, total won, and/or types of wagers placed).

In certain embodiments, a notification event occurs based on the satisfaction of one or more conditions. In these embodiments, the system causes one or more notifications to be communicated when certain criteria associated with the user of the client device, the user remote from the client device, the user of the streaming device, the streaming device and/or the streaming platform are met.

In certain embodiments, a condition association with an occurrence of a notification event includes a certain type of game (e.g., a poker game or a slot game) being played in association with a streaming session. In these embodiments, if that type of game is played in association with a streaming session (i.e., the condition is satisfied), the system causes one or more notifications to be communicated to one or more eligible users to make such users aware of the streaming session (and if that type of game is not played in association with the streaming session, no such notification is communicated). In certain additional or alternative embodiments, a condition association with an occurrence of a notification event includes a certain style of game (e.g., a casino game or a game of skill) being played in association with a streaming session. In these embodiments, if that style of game is played in association with a streaming session (i.e., the condition is satisfied), the system causes one or more notifications to be communicated to one or more eligible users to make such users aware of the streaming session (and if that style of game is not played in association with the streaming session, no such notification is communicated). In certain additional or alternative embodiments, a condition association with an occurrence of a notification event includes a certain game theme being played in association with a streaming session. In these embodiments, if that game theme is played in association with a streaming session (i.e., the condition is satisfied), the system causes one or more notifications to be communicated to one or more eligible users to make such users aware of the streaming session (and if that game theme is not played in association with the streaming session, no such notification is communicated).

In certain additional or alternative embodiments, a condition association with an occurrence of a notification event is based on an average expected payback percentage of a game being played in association with a streaming session. In these embodiments, if the game played in association with a streaming session has at least a threshold average expected payback percentage (i.e., the condition is satisfied), the system causes one or more notifications to be communicated to one or more eligible users to make such users aware of the streaming session (and if the game played in association with the streaming session does not have at least the threshold average expected payback percentage, no such notification is communicated). In certain additional or alternative embodiments, a condition association with an occurrence of a notification event is based on a minimum wager placed by the user of the streaming device on the game being played in association with a streaming session. In these embodiments, if the user of the streaming device is placing at least a minimum wager amount on one or more games played in association with a streaming session (i.e., the condition is satisfied), the system causes one or more notifications to be communicated to one or more eligible users to make such users aware of the streaming session (and if the user of the streaming device is not placing at least the minimum wager amount on such games played in association with the streaming session, no such notification is communicated). In certain additional or alternative embodiments, a condition association with an occurrence of a notification event is based on a minimum wager available to be placed by users of client devices in association with the game being streamed in association with a streaming session. In these embodiments, based on the minimum wager amount available for users of client devices, the system determines whether or not to cause one or more notifications to be communicated to one or more eligible users to make such users aware of the streaming session. For example, from a pool of subscribed users who engaged in a betting transaction recently, the system randomly selects one or more of such users and notifies such users of an opportunity to receive a bonus win (e.g., free spins and/or promo credits) if they reengage a client device.

In certain additional or alternative embodiments, a condition association with an occurrence of a notification event is based on a certain configuration of a streaming session (e.g., does the streaming session enable group wagering). In these embodiments, if the streaming session complies with that certain configuration, the system causes one or more notifications to be communicated to one or more eligible users to make such users aware of the streaming session (and if the streaming session does not comply, no such notification is communicated). In certain additional or alternative embodiments, a condition association with an occurrence of a notification event is based on one or more historical metrics of a user of the streaming device. Such historical metrics include, but are not limited to, a quantity of followers of the user of the streaming device, a win rate of the user of the streaming device, a play rate of the user of the streaming device and/or an average wager of the user of the streaming device. In these embodiments, if the user of the streaming device complies with one or more of these historical metrics, the system causes one or more notifications to be communicated to one or more eligible users to make such users aware of the streaming session (and if the user of the streaming device does not comply, no such notification is communicated). In certain additional or alternative embodiments, a condition association with an occurrence of a notification event is based on one or more metrics of the streaming session. Such metrics include, but are not limited to, a number of current viewers of the streaming session, a number of current users at client devices placing wagers in association with the streaming session, an amount won in association with the streaming session, an amount wagered in association with the streaming session, a rate of play associated with the streaming session, any winning streak (and/or losing streak) associated with the streaming session, a quantity of social media activity associated with the streaming session (or a particular event within the streaming session), and/or a quantity (or amount) of gifts associated with the streaming session. In these embodiments, if the streaming session complies with one or more of such metrics, the system causes one or more notifications to be communicated to one or more eligible users to make such users aware of the streaming session (and if the streaming session does not comply, no such notification is communicated).

In certain additional or alternative embodiments, a condition association with an occurrence of a notification event is based on one or more events occurring in association with one or more games played during a streaming session. Such events include, but are not limited to, an amount won in association with one or more games played during a streaming session, one or more winning outcomes (or winning outcomes of a certain win category) achieved in association with one or more games played during a streaming session, one or more near-miss outcomes achieved in association with one or more games played during a streaming session, one or more bonus events triggered in association with one or more games played during a streaming session. In these embodiments, if one or more of such events occur during the streaming session, the system causes one or more notifications to be communicated to one or more eligible users to make such users aware of the streaming session (and if such events do not occur during the streaming session, no such notification is communicated). In certain additional or alternative embodiments, a condition association with an occurrence of a notification event is based on one or more events wagered on by one or more users of client devices and occurring in association with one or more games played during a streaming session. In these embodiments, if one or more of such client device wagered on events occur during the streaming session, the system causes one or more notifications to be communicated to one or more eligible users to make such users aware of the streaming session (and if such client device wagered on events do not occur during the streaming session, no such notification is communicated). In certain additional or alternative embodiments, a condition association with an occurrence of a notification event is based on one or more states of a game (e.g., a persistent state such as, but not limited to, a state of a progressive award, a state of a dynamic multiplier and/or a state of one or more accumulated persistent elements) associated with a streaming session. In these embodiments, based on the state of a game of a streaming session, the system determines whether or not to cause one or more notifications to be communicated to one or more eligible users to make such users aware of the streaming session.

It should be appreciated that any of the above-described factors employed in determining whether a notification event occurred and/or any conditions associated with an occurrence of a notification event may additionally or alternatively be employed by any of the generative artificial intelligence models in determining the content of any generated notifications, whether a potential wagering event occurs, one or more parameters of any determined wagering opportunities, whether a content modification event occurred, and/or any modifications to any content. For example, one or more of an initiation of a streaming session, the enablement of a feature or capability of a streaming session, and/or an event occurring during a streaming session are used as one or more inputs in one or more artificial intelligence models in determining one or more of whether a notification event occurred, the content of any generated notifications, whether a potential wagering event occurred, one or more parameters of any determined wagering opportunities, whether a content modification event occurred, and/or any modifications to any content.

In certain embodiments, following an occurrence of a notification event and a determination of one or more eligible users to communicate a notification to, the system sends one or more notifications to such eligible users. In certain embodiments, the content associated with one or more notifications relates to the user of the streaming device and/or a configuration of the streaming device. In certain embodiments, the content associated with one or more notifications relates to a plurality of users of a plurality of streaming devices and/or a configuration of such streaming devices. For example, a casino might have three people currently streaming games from EGMs so the notifications represent a total (or average) of the activities of the three people streaming such games.

In certain embodiments, the content associated with one or more notifications relates to a configuration of the streaming session. In different embodiments, such configuration data conveyed via one or more notifications include, but is not limited to, the game being streamed, paytable information associated with the game being streamed, a duration of the streaming session, a time remaining of the streaming session, wagering activity associated with the streaming session, game outcome history associated with the streaming session, a minimum wager amount available to be placed by the user of the streaming device, a maximum wager amount available to be placed by the user at the streaming device, minimum wager amounts available to be placed by users at client devices, and maximum wager amounts available to be placed by users at client devices.

In certain embodiments, the content associated with one or more notifications relates to one or more events that occurred in the streaming environment. In these embodiments, the content of the notification is based on the current state of the streaming session (e.g., a quantity of viewers of the streaming session, a quantity of users at client devices placing wagers in association with the streaming session, and information regarding any winning (or losing) streaks occurring in the streaming session). In certain additional or alternative embodiments, the content associated with one or more notifications relates to one or more events that will potentially occur in the streaming environment and/or external to the streaming environment. In these embodiments, one or more determinations factor into whether or not such an event will or will not actually occur within and/or outside of the streaming environment. In different embodiments, one or more determinations associated with one or more users of one or more client devices, one or more client devices, a user of a streaming device, the streaming device, one or more components of the streaming platform and/or one or more components operating independent of the streaming platform, individually or collectively factor into whether an event associated with a notification that may potentially occur actually occurs.

It should be appreciated that any of the above-described factors employed in determining the content associated with one or more notifications may additionally or alternatively be employed by any of the generative artificial intelligence models in determining whether a notification event occurred, whether a potential wagering event occurred, one or more parameters of any determined wagering opportunities, whether a content modification event occurred, and/or any modifications to any content.

In certain embodiments, to encourage employment of such notifications (to drive additional activity to the streaming platform), the streaming platform enables all users to receive notifications as a complimentary service. In certain such embodiments, the system incentivizes users to participate in receiving such notifications, such as by providing a user a quantity of promotional credits to wager in association with the streaming platform upon every visit to a gaming establishment and/or subscribing to one or more events of the streaming platform which they are interested in receiving notifications about. In certain embodiments, the streaming platform enables an eligible user to receive notifications as a complimentary service. In different embodiments, eligibility of a user to receive notifications is based on one or more factors, such as a user needs to be carded in to receive any notifications, a user needs to be part of player loyalty program or have a certain status, a user needs to actively play with real money (not promotional credits), a user needs to have a positive balance on their account, and/or a user needs to qualify through one or more behaviors/achievements (e.g., engaging at a certain time/day, a quantity of visits, an amount spent and/or a quantity of friends recruited).

In certain embodiments, the streaming platform enables an eligible user to receive notifications for a fee, such as an amount of monetary credits or fiat currency, an amount of non-monetary credits, such as virtual money, or an amount of points associated with a gaming establishment patron management system (e.g., player tracking points) and/or associated with the streaming platform (e.g., streaming points). In certain instances, the fees to receive notifications vary based on notification activity otherwise occurring. In certain instances, different users are charged different fees for receiving notifications based on one or more attributes of the specific user and/or the event which the notification pertains to. In certain embodiments, the user subscribes to receiving one or more notifications to one or more events. In certain such embodiments, different user subscriptions levels determine the services/notification a user is eligible to subscribe to (e.g., Tier 1 provides that every event is available to be accessed, Tier 2 provides that personalized notifications are available and Tier 3 provides for general notifications). In certain embodiments, the user subscription enables the user to define the cadence of notifications (e.g., instant, daily, weekly) with certain notifications that the user is unable to opt-out from.

In certain embodiments, the streaming platform utilizes the automatic generation of notifications to indicate the status of wagers that have occurred during a streaming session. For example, if a user at a streaming device starts a game cycle, a notification component of the streaming platform automatically communicates a notification which includes information about how many wagers have been placed, a type of wager that has been placed, and/or the individual amounts and/or a total amount of such wagers, such as in the local currency and/or the currency of the user of the client device. The timing of such notifications is coordinated with the game cycle of the game being streamed by the streaming device.

In certain embodiments, the streaming platform utilizes the automatic generation of notifications to create one or more available inputs to be used to cause one or more actions to occur in association with a streaming session and/or independent of the streaming session. For example, in addition to communicating a notification which includes information about wagers placed, the notification component of the streaming platform automatically creates one or more inputs, such as “yes” and “no” buttons in the notification, that enable the user to participate in such wagering activity. In certain additional or alternative embodiments, the streaming platform utilizes one or more determinations associated with the user of the streaming device and/or attributes of the streaming session to create one or more available inputs associated with the generated notifications that are to be used to cause one or more actions to occur in association with a streaming session and/or independent of the streaming session. It should be appreciated that while described as automatically generating a notification in association with an initiation of a streaming session and/or one or more wagers placed, any suitable game event (e.g., wager placed at a streaming device, a wager placed at a client device, a game start, a game end, a game win, a game loss, a triggered bonus, a certain amount of money won at a client device, and/or a certain number of wins that occurred at a client device) may cause the automatic generation of a notification.

In certain embodiments, the streaming platform enables a user at a client device to place (and/or employs an artificial intelligence predictive model to place) a wager via a notification. In these embodiments, the streaming platform (and/or the client device) monitors the content of a notification and determines if the notification is associated with an opportunity to place a wager. In certain embodiments, the wager to be placed via a notification pertains to an event that may or may not occur in association with a streaming device. In certain embodiments, the wager to be placed via a notification pertains to an event based on, but otherwise distinct from, an event occurring in association with a streaming device.

In certain embodiments, following the user at the client device indicating an intention to place a wager responsive to receipt of a notification and in association with one or more events occurring (or potentially occurring), the streaming platform operates to place the wager subject to the client device being associated with adequate funds to place the wager. As such, the system of the present disclosure enables one or more actions to occur, such as the placement of one or more wagers, via notifications occurring in the streaming environment and independent of any non-notification inputs to otherwise cause the action to occur. Such a configuration of using notification facilitated wagers saves users at client devices time in not having to make certain inputs to place wagers (which prolongs the operational life of such client devices) and ensures that such users do not miss out of wagering opportunities due to certain timing delays occurring in the streaming environment.

In certain additional or alternative embodiments in which the content associated with one or more notifications relates to one or more events that will potentially occur, the streaming platform utilizes notifications to invite one or more users to perform an action independent of any wagering activity. In one such embodiment, the content of the notification relates to an invitation of a user to become a follower of the user of the streaming device. In another such embodiment, the content of the notification relates to an invitation of a user to create one or more accounts (e.g., a streaming account of the streaming platform and/or an account of a gaming establishment patron management system). In another such embodiment, the content of the notification relates to an invitation to give praise to the user of the streaming device and/or a user of a client device. In another such embodiment, the content of the notification relates to an invitation to send a gift (i.e., a cash or financial gift or a non-cash gift, such as loyalty points or promotional credits) as congratulations for one or more notifications. It should be appreciated that in different embodiments, the notification generated by the streaming platform (with or without any input from any user of any client device and/or any user of any streaming device) relates to an invitation associated with any event of the present disclosure and/or any action of the present disclosure.

In certain embodiments, the streaming platform employs certain configurations that determine any modifications to any notifications. For example, in association with the creation of one or more notifications, a notification component (and/or underlying device which will display the notification) utilizes a language preference of the receiving device. Such a configuration (which may be stored in association with the device itself and/or an account associated with the user of the device) enables the notification component to translate notifications to the appropriate language (e.g., the same notification is modified to English for viewing at one client device and modified to Spanish for viewing at another client device).

In certain embodiments, the streaming platform employs certain configurations that determine which notifications may be sent to which users and which notifications are filtered out from being sent to zero, one or more users. In one such embodiment, the streaming platform employs one or more of the above-described factors used to determine a user's eligibility to participate in receiving notifications to determine whether or not that user is eligible to receive a particular notification.

In certain embodiments, the content of a particular notification additionally or alternatively determines the destination of the notification. In one such embodiment, the streaming platform filters out any wagering or gambling notifications sent to any users below a certain age, such as any users at any client devices under the age of twenty-one. In another such embodiment, the streaming platform filters out any wagering or gambling notifications sent to any users who do not have one or more accounts associate with the streaming platform (and thus are currently not capable of placing any wagers in association with a streamed game).

In certain embodiments, the streaming platform associates additional content with one or more notifications. In these embodiments, the system conveys additional content associated with one or more notifications via modifying how the notification conveyed, such as employing different colors, different fonts, different sizes and/or different icons in association with content (e.g., username and text) attributed to a particular user to convey different information associated with that user.

It should be appreciated that in using any of the generative artificial intelligence models in determining whether a notification event occurred, the content of any generated notifications, whether a potential wagering event occurred, one or more parameters of any determined wagering opportunities, whether a content modification event occurred, and/or any modifications to any content, the system of certain embodiments operates to enhance the artificial intelligence model based on different inputs and/or outputs. In certain such embodiments, the artificial intelligence model collects data from one or more surveys undertaken by one or more users and adjusts how it operates based on such collected data. In certain additional or alternative embodiments, the artificial intelligence model measures a success rate (and/or a failure rate) of certain actions and adjusts operations based on such measured successes (and/or failures). For example, the generative artificial intelligence models are equipped with a functionality that measures the success rate of notifications (e.g., if the user responds to an invitation, and/or if a user follows an invitation). In this example, based upon the success rate, zero, one or more measures that are considered successful (e.g., a response score above a threshold score) are retained (and further improved upon) and zero, one or more measures that are considered failures (e.g., a response score below a threshold score) are discarded. Additionally, personalized measures that are considered successful (e.g., a response score above a threshold score) are re-used for similar user profiles. In certain such embodiments, the system groups measures according to available user clusters if a certain success threshold is met. For example, if notification success rate of a progressive award notification is found appealing by a cluster of users quantified as gamblers, the system notifies all users quantified as gamblers once such an event occurs.

In certain embodiments, to enable the artificial intelligence model to operate, the model-running streaming platform (and/or client device or streaming device) is connected to the internet directly, to retrieve, as needed, content from online. In certain other embodiments, to enable the artificial intelligence model to operate, the artificial intelligence model is trained using any suitable training procedure and processes data from a streaming platform database (e.g., including, but not limited to, all game assets). In certain other embodiments, to enable the artificial intelligence model to operate, the streaming platform (and/or client device or streaming device) is connected to a gaming establishment management system which enables for the connection of the artificial intelligence model with the internet to provide more network security layers could be applied.

It should be appreciated that one or more different types of artificial intelligence models may be used to effectuate any of the specific embodiments of the present disclosure. In certain embodiments, data clustering using an artificial neural network is one type of model the system employs to personalize how different users engage the streaming environment. In these embodiments, an artificial neural network is a computing system having a structure that is inspired by biological neural networks. Such systems may “learn” by using data clustering and/or other techniques how to process input data, such as by considering prior known examples of input vectors and automatically adapting the network to produce the same results. In such embodiments, an artificial neural network is based on a collection of connected units or nodes which act as artificial neurons and are connected by a mesh of connectors which simulate synapses. Each connection between nodes transmits a signal from one node to another. The artificial neuron that receives the signal processes the signal and then signals connected artificial neurons. For example, in an artificial neural network implementation, the signal at a connection between nodes is a number, and the output of each node is calculated by a non-linear function of the sum of its inputs. Such a function is considered a “combinational function” because it combines the outputs of other nodes. Nodes and/or connections typically have a weight that adjusts as learning proceeds with the weight increasing or decreasing the strength of the signal at a connection. Certain such nodes have a threshold such that a signal is sent only if the aggregate signal exceeds that threshold. In this example, nodes are organized in layers, where different layers perform different kinds of transformations on their inputs and signals travel from the first (input) layer of nodes to the last (output) layer of nodes. “Learning” or training of artificial neural networks is performed by a process of backpropagation in which known outcomes are propagated back through the network, and the weights are adjusted according to a gradient function so that the system produces the known outcome in response to a particular input state, where an “input state” is the vector of input parameter values. Backpropagation is considered a supervised training technique, because it uses a known output state for each input state that is trained.

As such, in certain embodiments, the systems of the present disclosure operate with one or more supervised learning artificial intelligence processes (i.e., that include pre-categorized or labeled data, and/or require examples of desired output data which may guide the AI artificial intelligence toward an intended result), such as retrieval-based artificial intelligence or other processes that may employ training data to increase accuracy and efficiency. In certain other embodiments, in conjunction with or as an alternative to unsupervised learning, the systems of the present disclosure operate with one or more unsupervised learning artificial intelligence processes (i.e., that do not require raw input to be pre-categorized or labeled and/or do not require examples of desired output data), such as visualization, clustering, transfer learning, nearest neighbor, and/or deep learning artificial intelligence models.

The above-described embodiments of the present disclosure may be implemented in accordance with or in conjunction with one or more of a variety of different types of systems, such as, but not limited to, those described below.

The present disclosure contemplates a variety of different systems each having one or more of a plurality of different features, attributes, or characteristics. A “streaming device” and/or “client device” as used herein refers to various configurations of: (a) one or more servers; (b) one or more electronic gaming machines; (c) one or more components of a gaming establishment management system associated with an electronic gaming machine, such as a slot machine interface board; (d) one or more devices associated with an electronic gaming machine, such as a slot machine interface board, operating independent of any components of a gaming establishment management system, and/or (e) one or more personal gaming devices (e.g., desktop computers, laptop computers, tablet computers or computing devices, personal digital assistants, mobile phones, and other mobile computing devices). Thus, in various embodiments, the streaming devices and client devices of the present disclosure include: (a) one or more electronic gaming machines in combination with one or more servers; (b) one or more slot machine interface boards (or other components of a gaming establishment management system or other components independent of a gaming establishment management system) in communication with one or more servers; (c) one or more personal gaming devices in combination with one or more servers; (d) one or more personal gaming devices in combination with one or more electronic gaming machines; (e) one or more personal gaming devices in combination with one or more slot machine interface boards (or other components of a gaming establishment management system or other components independent of a gaming establishment management system); (f) one or more personal gaming devices, one or more electronic gaming machines, one or more slot machine interface boards (or other components of a gaming establishment management system or other components independent of a gaming establishment management system) and one or more servers in combination with one another; (g) a single electronic gaming machine; (h) a plurality of electronic gaming machines in combination with one another; (i) a single personal gaming device; (j) a plurality of personal gaming devices in combination with one another; (k) as single slot machine interface board (or another component of a gaming establishment management system or another component independent of a gaming establishment management system); (l) a plurality of slot machine interface boards (or other components of a gaming establishment management system or other components independent of a gaming establishment management system) in combination with one another; (m) a single server; and/or (n) a plurality of servers in combination with one another. For brevity and clarity and unless specifically stated otherwise, “streaming device as used herein represents one streaming device or a plurality of streaming devices, “client device” as used herein represents one client device or a plurality of client devices and “server” as used herein represents one server or a plurality of servers.

As noted above, in various embodiments, the system includes a streaming device and/or a client device in combination with a server. In such embodiments, the streaming device and/or client device is configured to communicate with the server through a data network or remote communication link. In certain such embodiments, the streaming device and/or client device is configured to communicate with another streaming device and/or client device through the same data network or remote communication link or through a different data network or remote communication link.

In certain embodiments in which the system includes a streaming device and/or a client device in combination with a server, the server is any suitable computing device (such as a server) that includes at least one processor and at least one memory device or data storage device. As further described herein, the streaming device and/or client device includes at least one streaming device and/or client device processor configured to transmit and receive data or signals representing events, messages, commands, or any other suitable information between the streaming device and/or client device and the server. The at least one processor of that streaming device and/or client device is configured to execute the events, messages, or commands represented by such data or signals in conjunction with the operation of the streaming device and/or client device. Moreover, the at least one processor of the server is configured to transmit and receive data or signals representing events, messages, commands, or any other suitable information between the server and the streaming device and/or client device. The at least one processor of the server is configured to execute the events, messages, or commands represented by such data or signals in conjunction with the operation of the server. One, more than one, or each of the functions of the server may be performed by the at least one processor of the streaming device and/or client device. Further, one, more than one, or each of the functions of the at least one processor of the streaming device and/or client device may be performed by the at least one processor of the server.

In certain such embodiments, computerized instructions for controlling any games (such as any primary or base games and/or any secondary or bonus games) displayed by the streaming device and/or client device are executed by the server. In such “thin client” embodiments, the server remotely controls any games (or other suitable interfaces) displayed by the streaming device and/or client device, and the streaming device and/or client device is utilized to display such games (or suitable interfaces) and to receive one or more inputs or commands. In other such embodiments, computerized instructions for controlling any games displayed by the streaming device and/or client device are communicated from the server to the streaming device and/or client device and are stored in at least one memory device of the streaming device and/or client device. In such “thick client” embodiments, the at least one processor of the streaming device and/or client device executes the computerized instructions to control any games (or other suitable interfaces) displayed by the streaming device and/or client device.

In various embodiments in which the system includes a plurality of streaming devices and/or client devices, one or more of the streaming devices and/or client devices are thin client streaming devices and/or client devices and one or more of the streaming devices and/or client devices are thick client streaming devices and/or client devices. In other embodiments in which the system includes one or more streaming devices and/or client devices, certain functions of one or more of the streaming devices and/or client devices are implemented in a thin client environment, and certain other functions of one or more of the streaming devices and/or client devices are implemented in a thick client environment. In one such embodiment in which the system includes a streaming device and/or a client device and a server, computerized instructions for controlling any primary or base games displayed by the streaming device and/or client device are communicated from the server to the streaming device and/or client device in a thick client configuration, and computerized instructions for controlling any secondary or bonus games or other functions displayed by the streaming device and/or client device are executed by the server in a thin client configuration.

In certain embodiments in which the system includes: (a) a streaming device and/or a client device configured to communicate with a server through a data network; and/or (b) a plurality of streaming devices and/or client devices configured to communicate with one another through a data network, the data network is a local area network (LAN) in which the streaming devices and/or client devices are located substantially proximate to one another and/or the server. In one example, the streaming devices and/or client devices and the server are located in a gaming establishment or a portion of a gaming establishment. In other embodiments in which the system includes: (a) a streaming device and/or a client device configured to communicate with a server through a data network; and/or (b) a plurality of streaming devices and/or client devices configured to communicate with one another through a data network, the data network is a wide area network (WAN) in which one or more of the streaming devices and/or client devices are not necessarily located substantially proximate to another one of the streaming devices and/or client devices and/or the server. For example, one or more of the streaming devices and/or client devices are located: (a) in an area of a gaming establishment different from an area of the gaming establishment in which the server is located; or (b) in a gaming establishment different from the gaming establishment in which the server is located. In another example, the server is not located within a gaming establishment in which the streaming devices and/or client devices are located. In certain embodiments in which the data network is a WAN, the system includes a server and a streaming device and/or a client device each located in a different gaming establishment in a same geographic area, such as a same city or a same state. Systems in which the data network is a WAN are substantially identical to systems in which the data network is a LAN, though the quantity of streaming devices and/or client devices in such systems may vary relative to one another.

In further embodiments in which the system includes: (a) a streaming device and/or a client device configured to communicate with a server through a data network; and/or (b) a plurality of streaming devices and/or client devices configured to communicate with one another through a data network, the data network is an internet or an intranet. In certain such embodiments, an internet browser of the streaming device and/or client device is usable to access an internet game page from any location where an internet connection is available. In one such embodiment, after the streaming device and/or client device accesses the internet game page, the server identifies a user before enabling that user to place any wagers on any plays of any wagering games. In one example, the server identifies the user by requiring a user account of the user to be logged into via an input of a unique username and password combination assigned to the user. The server may, however, identify the user in any other suitable manner, such as by validating a player tracking identification number associated with the user; by reading a player tracking card or other smart card inserted into a card reader (as described below); by validating a unique user identification number associated with the user by the server; or by identifying the streaming device and/or client device, such as by identifying the MAC address or the IP address of the internet facilitator. In various embodiments, once the server identifies the user, the server enables placement of one or more wagers on one or more plays of one or more primary or base games and/or one or more secondary or bonus games, and displays those plays via the internet browser of the streaming device and/or client device.

The server and the streaming device and/or client device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium.

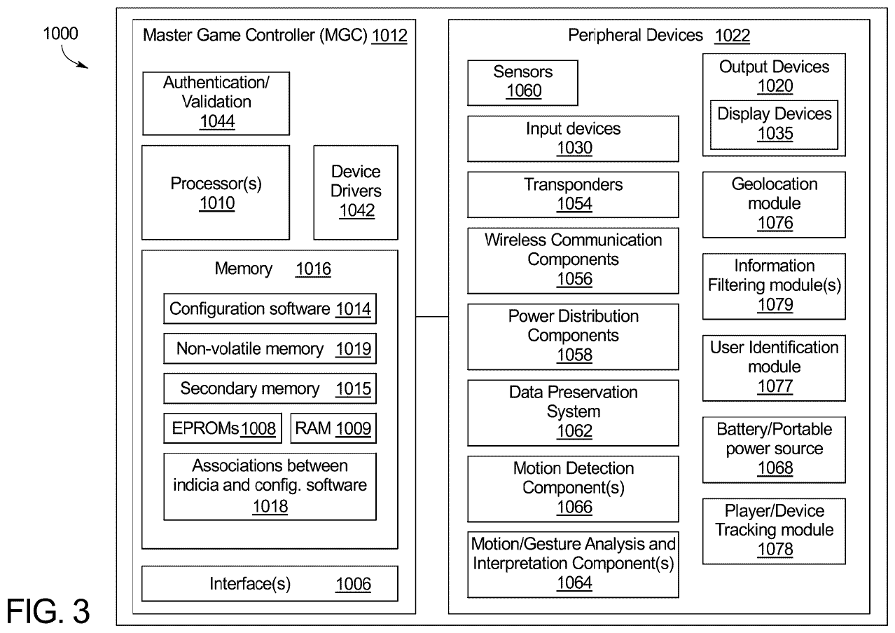

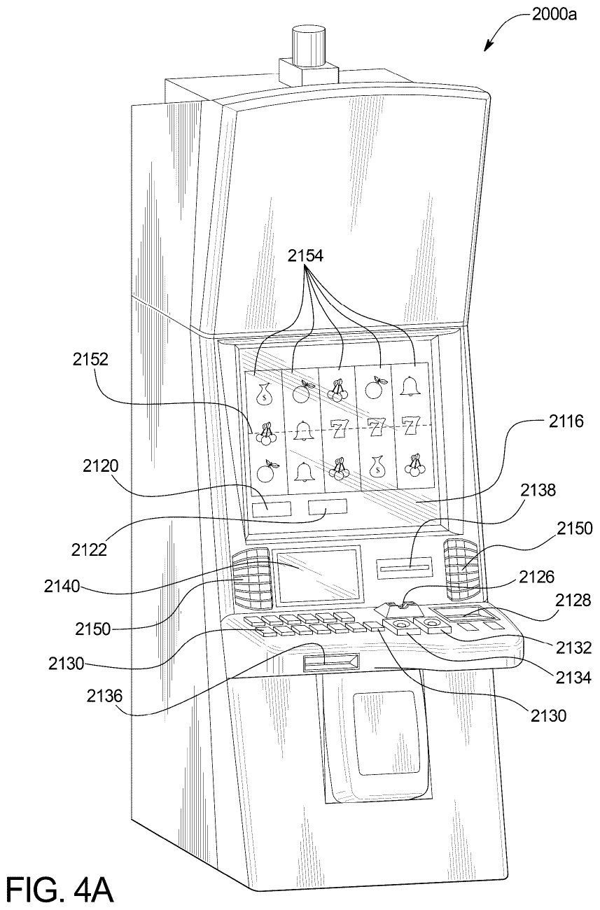

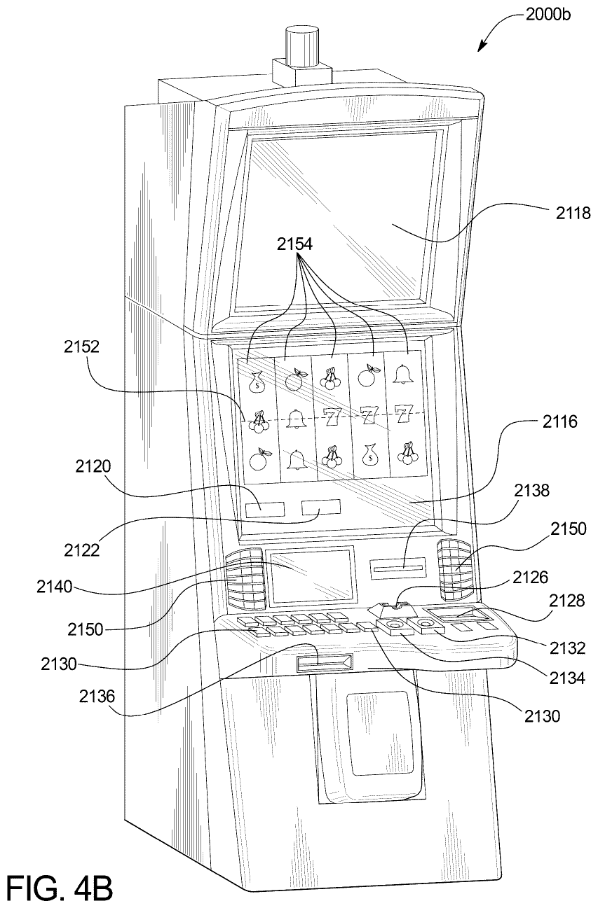

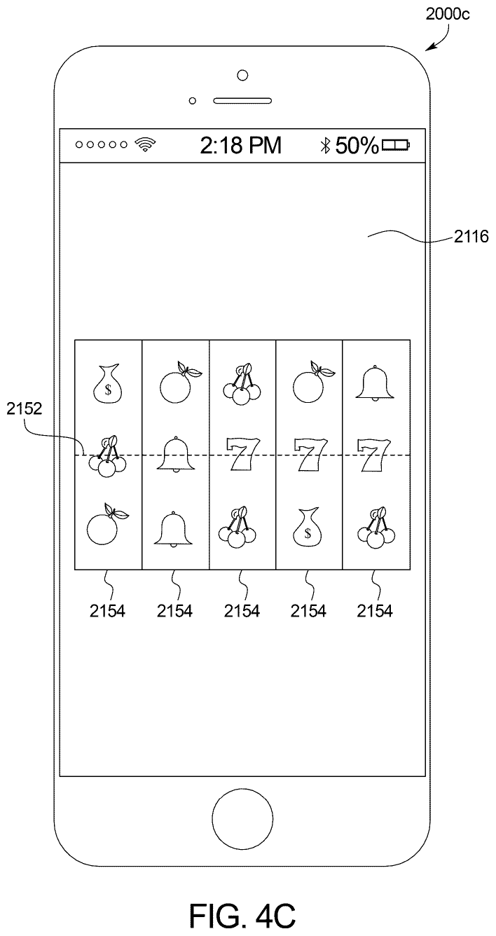

FIG. 3 is a block diagram of an example streaming device and/or client device 1000 and FIGS. 4A and 4B include two different example streaming devices and/or client devices 2000a and 2000b. The streaming devices and/or client devices 1000, 2000a, and 2000b are merely example streaming devices and/or client devices, and different streaming devices and/or client devices may be implemented using different combinations of the components shown in the streaming devices and/or the client devices 1000, 2000a, and 2000b. Although the below refers to streaming devices and/or client devices, in various embodiments personal gaming devices (such as personal gaming device 2000c of FIG. 4C) may include some or all of the below components.

In these embodiments, the streaming device and/or the client device 1000 includes a master gaming controller 1012 configured to communicate with and to operate with a plurality of peripheral devices 1022.

The master gaming controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or game information) via a communication interface 1006 of the master gaming controller 1012; (2) converting signals read by an interface to a format corresponding to that used by software or memory of the streaming device and/or the client device; (3) accessing memory to configure or reconfigure game parameters in the memory according to indicia read from the streaming device and/or the client device; (4) communicating with interfaces and the peripheral devices 1022 (such as input/output devices); and/or (5) controlling the peripheral devices 1022. In certain embodiments, one or more components of the master gaming controller 1012 (such as the at least one processor 1010) reside within a housing of the streaming device and/or the client device (described below), while in other embodiments at least one component of the master gaming controller 1012 resides outside of the housing of the streaming device and/or the client device.

The master gaming controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store gaming software related information (the gaming software related information and the memory may be used to store various audio files and games not currently being used and invoked in a configuration or reconfiguration). Any other suitable magnetic, optical, and/or semiconductor memory may operate in conjunction with the streaming device and/or the client device of the present disclosure. In certain embodiments, the at least one memory device 1016 resides within the housing of the streaming device and/or the client device (described below), while in other embodiments at least one component of the at least one memory device 1016 resides outside of the housing of the streaming device and/or the client device.

The at least one memory device 1016 is configured to store, for example: (1) configuration software 1014, such as all the parameters and settings for a game playable on the streaming device and/or the client device; (2) associations 1018 between configuration indicia read from a streaming device and/or a client device with one or more parameters and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the streaming device and/or the client device to communicate with local and non-local devices using such protocols. In one implementation, the master gaming controller 1012 communicates with other devices using a serial communication protocol. A few non-limiting examples of serial communication protocols that other devices, such as peripherals (e.g., a bill validator or a ticket printer), may use to communicate with the master game controller 1012 include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device 1016 is configured to store program code and instructions executable by the at least one processor of the streaming device and/or the client device to control the streaming device and/or the client device. The at least one memory device 1016 of the streaming device and/or the client device also stores other operating data, such as image data, event data, input data, random number generators (RNGs) or pseudo-RNGs, paytable data or information, and/or applicable game rules that relate to the play of one or more games on the streaming device and/or the client device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a user uses such a removable memory device in a streaming device and/or a client device to implement at least part of the present disclosure. In other embodiments, part or all of the program code and/or the operating data is downloaded to the at least one memory device of the streaming device and/or the client device through any suitable data network described above (such as an internet or intranet).

The at least one memory device 1016 also stores a plurality of device drivers 1042. Examples of different types of device drivers include device drivers for streaming device and/or client device components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the streaming device and/or the client device. Non-limiting examples of communication protocols used to implement the device drivers include Netplex, USB, Serial, Ethernet 175, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the streaming device and/or the client device loads the new device driver from the at least one memory device to enable communication with the new device. For instance, one type of card reader in the streaming device and/or the client device can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new games, new game options, new parameters, new settings for existing parameters, new settings for new parameters, new device drivers, and new communication protocols can be uploaded to the at least one memory device 1016 from the master game controller 1012 or from some other external device. As another example, when the at least one memory device 1016 includes a CD/DVD drive including a CD/DVD configured to store game options, parameters, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store games, game options, parameters, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device 1016 also stores authentication and/or validation components 1044 configured to authenticate/validate specified streaming device and/or client device components and/or information, such as hardware components, software components, firmware components, peripheral device components, user input device components, information received from one or more user input devices, information stored in the at least one memory device 1016, etc.

In certain embodiments, the peripheral devices 1022 include several device interfaces, such as: (1) at least one output device 1020 including at least one display device 1035; (2) at least one input device 1030 (which may include contact and/or non-contact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one user identification module 1077; (13) at least one user/device tracking module 1078; and (14) at least one information filtering module 1079.

The at least one output device 1020 includes at least one display device 1035 configured to display any game(s) displayed by the streaming device and/or the client device and any suitable information associated with such game(s). In certain embodiments, the display devices are connected to or mounted on a housing of the streaming device and/or the client device (described below). In various embodiments, the display devices serve as digital glass configured to advertise certain games or other aspects of the gaming establishment in which the streaming device and/or the client device is located. In various embodiments, the streaming device and/or the client device includes one or more of the following display devices: (a) a central display device; (b) a player tracking display configured to display various information regarding a user's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example streaming device and/or client device 2000a illustrated in FIG. 4A includes a central display device 2116, a player tracking display 2140, a credit display 2120, and a bet display 2122. The example streaming device and/or client device 2000b illustrated in FIG. 4B includes a central display device 2116, an upper display device 2118, a player tracking display 2140, a credit display 2120, and a bet display 2122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The display devices of the streaming device and/or the client device are configured to display one or more game and/or non-game images, symbols, and indicia. In certain embodiments, the display devices of the streaming device and/or the client device are configured to display any suitable visual representation or exhibition of the movement of objects; dynamic lighting; video images; images of people, characters, places, things, and faces of cards; and the like. In certain embodiments, the display devices of the streaming device and/or the client device are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device 1020 includes a payout device. In these embodiments, after the streaming device and/or the client device receives an actuation of a cashout device (described below), the streaming device and/or the client device causes the payout device to provide a payment to the user. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. The example streaming devices and/or client devices 2000a and 2000b illustrated in FIGS. 4A and 4B each include a ticket printer and dispenser 2136.

In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account, a casino account, or a prepaid account of the user; via a transfer of funds onto an electronically recordable identification card or smart card of the user; or via sending a virtual ticket having a monetary value to an electronic device of the user. While any credit balances, any wagers, any values, and any awards are described herein as amounts of monetary credits or currency, one or more of such credit balances, such wagers, such values, and such awards may be for non-monetary credits, promotional credits, of player tracking points or credits.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any games or by playing music for other modes of the streaming device and/or the client device, such as an attract mode. The example streaming devices and/or client devices 2000a and 2000b illustrated in FIGS. 4A and 4B each include a plurality of speakers 2150. In another such embodiment, the streaming device and/or the client device provides dynamic sounds coupled with attractive multimedia images displayed on one or more of the display devices to provide an audio-visual representation or to otherwise display full-motion video with sound to attract users to the streaming device and/or the client device. In certain embodiments, the streaming device and/or the client device displays a sequence of audio and/or visual attraction messages during idle periods to attract potential users to the streaming device and/or the client device. The videos may be customized to provide any appropriate information.

The at least one input device 1030 may include any suitable device that enables an input signal to be produced and received by the at least one processor 1010 of the streaming device and/or the client device.

In one embodiment, the at least one input device 1030 includes a payment device configured to communicate with the at least one processor of the streaming device and/or the client device to fund the streaming device and/or the client device. In certain embodiments, the payment device includes one or more of: (a) a bill acceptor into which paper money is inserted to fund the streaming device and/or the client device; (b) a ticket acceptor into which a ticket or a voucher is inserted to fund the streaming device and/or the client device; (c) a coin slot into which coins or tokens are inserted to fund the streaming device and/or the client device; (d) a reader or a validator for credit cards, debit cards, or credit slips into which a credit card, debit card, or credit slip is inserted to fund the streaming device and/or the client device; (e) a user identification card reader into which a user identification card is inserted to fund the streaming device and/or the client device; or (f) any suitable combination thereof. The example streaming devices and/or client devices 2000a and 2000b illustrated in FIGS. 4A and 4B each include a combined bill and ticket acceptor 2128 and a coin slot 2126.

In one embodiment, the at least one input device 1030 includes a payment device configured to enable the streaming device and/or the client device to be funded via an electronic funds transfer, such as a transfer of funds from a bank account. In another embodiment, the streaming device and/or the client device includes a payment device configured to communicate with a mobile device of a user, such as a mobile phone, a radio frequency identification tag, or any other suitable wired or wireless device, to retrieve relevant information associated with that user to fund the streaming device and/or the client device. When the streaming device and/or the client device is funded, the at least one processor determines the amount of funds entered and displays the corresponding amount on a credit display or any other suitable display as described below.

In certain embodiments, the at least one input device 1030 includes at least one wagering or betting device. In various embodiments, the one or more wagering or betting devices are each: (1) a mechanical button supported by the housing of the streaming device and/or the client device (such as a hard key or a programmable soft key), or (2) an icon displayed on a display device of the streaming device and/or the client device (described below) that is actuatable via a touch screen of the streaming device and/or the client device (described below) or via use of a suitable input device of the streaming device and/or the client device (such as a mouse or a joystick). One such wagering or betting device is as a maximum wager or bet device that, when actuated, causes the streaming device and/or the client device to place a maximum wager on a play of a game. Another such wagering or betting device is a repeat bet device that, when actuated, causes the streaming device and/or the client device to place a wager that is equal to the previously-placed wager on a play of a game. A further such wagering or betting device is a bet one device that, when actuated, causes the streaming device and/or the client device to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments, the at least one input device 1030 includes at least one game play activation device. In various embodiments, the one or more game play initiation devices are each: (1) a mechanical button supported by the housing of the streaming device and/or the client device (such as a hard key or a programmable soft key), or (2) an icon displayed on a display device of the streaming device and/or the client device (described below) that is actuatable via a touch screen of the streaming device and/or the client device (described below) or via use of a suitable input device of the streaming device and/or the client device (such as a mouse or a joystick). After a user appropriately funds the streaming device and/or the client device and places a wager, the streaming device and/or the client device activates the game play activation device to enable the user to actuate the game play activation device to initiate a play of a game on the streaming device and/or the client device (or another suitable sequence of events associated with the streaming device and/or the client device). After the streaming device and/or the client device receives an actuation of the game play activation device, the streaming device and/or the client device initiates the play of the game. The example streaming devices and/or client devices 2000a and 2000b illustrated in FIGS. 4A and 4B each include a game play activation device in the form of a game play initiation button 2132. In other embodiments, the streaming device and/or the client device begins game play automatically upon appropriate funding rather than upon utilization of the game play activation device.

In other embodiments, the at least one input device 1030 includes a cashout device. In various embodiments, the cashout device is: (1) a mechanical button supported by the housing of the streaming device and/or the client device (such as a hard key or a programmable soft key), or (2) an icon displayed on a display device of the streaming device and/or the client device (described below) that is actuatable via a touch screen of the streaming device and/or the client device (described below) or via use of a suitable input device of the streaming device and/or the client device (such as a mouse or a joystick). When the streaming device and/or the client device receives an actuation of the cashout device from a user and the user has a positive (i.e., greater-than-zero) credit balance, the streaming device and/or the client device initiates a payout associated with the user's credit balance. The example streaming devices and/or client devices 2000a and 2000b illustrated in FIGS. 4A and 4B each include a cashout device in the form of a cashout button 2134.

In various embodiments, the at least one input device 1030 includes a plurality of buttons that are programmable by the streaming device and/or the client device operator to, when actuated, cause the streaming device and/or the client device to perform particular functions. For instance, such buttons may be hard keys, programmable soft keys, or icons icon displayed on a display device of the streaming device and/or the client device (described below) that are actuatable via a touch screen of the streaming device and/or the client device (described below) or via use of a suitable input device of the streaming device and/or the client device (such as a mouse or a joystick). The example streaming devices and/or client devices 2000a and 2000b illustrated in FIGS. 4A and 4B each include a plurality of such buttons 2130.

In certain embodiments, the at least one input device 1030 includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the streaming device and/or the client device by touching the touch screen at the appropriate locations.

In embodiments including a player tracking system, as further described below, the at least one input device 1030 includes a card reader in communication with the at least one processor of the streaming device and/or the client device. The example streaming devices and/or client devices 2000a and 2000b illustrated in FIGS. 4A and 4B each include a card reader 2138. The card reader is configured to read a user identification card inserted into the card reader.

The at least one wireless communication component 1056 includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more user input devices near the streaming device and/or the client device. In one embodiment, a user input device docking region is provided, and includes a power distribution component that is configured to recharge a user input device without requiring metal-to-metal contact. In one embodiment, the at least one power distribution component 1058 is configured to distribute power to one or more internal components of the streaming device and/or the client device, such as one or more rechargeable power sources (e.g., rechargeable batteries) located at the streaming device and/or the client device.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the streaming device and/or the client device; detecting the presence and/or identity of various persons (e.g., users, casino employees, etc.), devices (e.g., user input devices), and/or systems within a predetermined proximity to the streaming device and/or the client device.

The at least one data preservation component 1062 is configured to detect or sense one or more events and/or conditions that, for example, may result in damage to the streaming device and/or the client device and/or that may result in loss of information associated with the streaming device and/or the client device. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected user movements and/or gestures to determine appropriate user input information relating to the detected user movements and/or gestures. For example, in one embodiment, the at least one motion/gesture analysis and interpretation component 1064 is configured to perform one or more of the following functions: analyze the detected gross motion or gestures of a user; interpret the user's motion or gestures (e.g., in the context of a casino game being played) to identify instructions or input from the user; utilize the interpreted instructions/input to advance the game state; etc. In other embodiments, at least a portion of these additional functions may be implemented at a remote system or device.

The at least one portable power source 1068 enables the streaming device and/or the client device to operate in a mobile environment. For example, in one embodiment, the streaming device and/or the client device includes one or more rechargeable batteries.

The at least one geolocation module 1076 is configured to acquire geolocation information from one or more remote sources and use the acquired geolocation information to determine information relating to a relative and/or absolute position of the streaming device and/or the client device. For example, in one implementation, the at least one geolocation module 1076 is configured to receive GPS signal information for use in determining the position or location of the streaming device and/or the client device. In another implementation, the at least one geolocation module 1076 is configured to receive multiple wireless signals from multiple remote devices (e.g., streaming devices and/or client devices, servers, wireless access points, etc.) and use the signal information to compute position/location information relating to the position or location of the streaming device and/or the client device.

The at least one user identification module 1077 is configured to determine the identity of the current user or current owner of the streaming device and/or the client device. For example, in one embodiment, the current user is required to perform a login process at the streaming device and/or the client device in order to access one or more features. Alternatively, the streaming device and/or the client device is configured to automatically determine the identity of the current user based on one or more external signals, such as an RFID tag or badge worn by the current user and that provides a wireless signal to the streaming device and/or the client device that is used to determine the identity of the current user. In at least one embodiment, various security features are incorporated into the streaming device and/or the client device to prevent unauthorized users from accessing confidential or sensitive information.

The at least one information filtering module 1079 is configured to perform filtering (e.g., based on specified criteria) of selected information to be displayed at one or more displays 1035 of the streaming device and/or the client device.

In various embodiments, the streaming device and/or the client device includes a plurality of communication ports configured to enable the at least one processor of the streaming device and/or the client device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, such as the example streaming devices and/or client devices 2000a and 2000b illustrated in FIGS. 4A and 4B, the streaming device and/or the client device has a support structure, housing, or cabinet that provides support for a plurality of the input devices and the output devices of the streaming device and/or the client device. Further, the streaming device and/or the client device is configured such that a user may operate it while standing or sitting. In various embodiments, the streaming device and/or the client device is positioned on a base or stand, or is configured as a pub-style tabletop game (not shown) that a user may operate typically while sitting. As illustrated by the different example streaming devices and/or client devices 2000a and 2000b shown in FIGS. 4A and 4B, streaming devices and/or client devices may have varying housing and display configurations.

In certain embodiments, the streaming device and/or the client device is a device that has obtained approval from a regulatory gaming commission, and in other embodiments, the streaming device and/or the client device is a device that has not obtained approval from a regulatory gaming commission.

The streaming devices and/or client devices described above are merely three examples of different types of streaming devices and/or client devices. Certain of these example streaming devices and/or client devices may include one or more elements that may not be included in all systems, and these example streaming devices and/or client devices may not include one or more elements that are included in other systems. For example, certain streaming devices and/or client devices include a coin acceptor while others do not.

In various embodiments, a streaming device and/or a client device may be implemented in one of a variety of different configurations. In various embodiments, the streaming device and/or the client device may be implemented as one of: (a) a dedicated streaming device and/or client device in which computerized game programs executable by the streaming device and/or the client device for controlling any primary or base games (referred to herein as “primary games”) and/or any secondary or bonus games or other functions (referred to herein as “secondary games”) displayed by the streaming device and/or the client device are provided with the streaming device and/or the client device before delivery to a gaming establishment or before being provided to a user; and (b) a changeable streaming device and/or client device in which computerized game programs executable by the streaming device and/or the client device for controlling any primary games and/or secondary games displayed by the streaming device and/or the client device are downloadable or otherwise transferred to the streaming device and/or the client device through a data network or remote communication link; from a USB drive, flash memory card, or other suitable memory device; or in any other suitable manner after the streaming device and/or the client device is physically located in a gaming establishment or after the streaming device and/or the client device is provided to a user.

As generally explained above, in various embodiments in which the system includes a server and a changeable streaming device and/or client device, the at least one memory device of the server stores different game programs and instructions executable by the at least one processor of the changeable streaming device and/or client device to control one or more primary games and/or secondary games displayed by the changeable streaming device and/or client device. More specifically, each such executable game program represents a different game or a different type of game that the at least one changeable streaming device and/or client device is configured to operate. In one example, certain of the game programs are executable by the changeable streaming device and/or client device to operate games having the same or substantially the same game play but different paytables. In different embodiments, each executable game program is associated with a primary game, a secondary game, or both. In certain embodiments, an executable game program is executable by the at least one processor of the at least one changeable streaming device and/or client device as a secondary game to be played simultaneously with a play of a primary game (which may be downloaded to or otherwise stored on the at least one changeable streaming device and/or client device), or vice versa.

In operation of such embodiments, the server is configured to communicate one or more of the stored executable game programs to the at least one processor of the changeable streaming device and/or client device. In different embodiments, a stored executable game program is communicated or delivered to the at least one processor of the changeable streaming device and/or client device by: (a) embedding the executable game program in a device or a component (such as a microchip to be inserted into the changeable streaming device and/or client device); (b) writing the executable game program onto a disc or other media; or (c) uploading or streaming the executable game program over a data network (such as a dedicated data network). After the executable game program is communicated from the server to the changeable streaming device and/or client device, the at least one processor of the changeable streaming device and/or client device executes the executable game program to enable the primary game and/or the secondary game associated with that executable game program to be played using the display device(s) and/or the input device(s) of the changeable streaming device and/or client device. That is, when an executable game program is communicated to the at least one processor of the changeable streaming device and/or client device, the at least one processor of the changeable streaming device and/or client device changes the game or the type of game that may be played using the changeable streaming device and/or client device.

In certain embodiments, the system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the system generates the game outcome(s) and/or the award(s) to be provided based on the associated probabilities. In these embodiments, since the system generates game outcomes and/or awards randomly or based on one or more probability calculations, there is no certainty that the system will ever provide any specific game outcome and/or award.

In certain embodiments, the system maintains one or more predetermined pools or sets of predetermined game outcomes and/or awards. In certain such embodiments, upon generation or receipt of a game outcome and/or award request, the system independently selects one of the predetermined game outcomes and/or awards from the one or more pools or sets. The system flags or marks the selected game outcome and/or award as used. Once a game outcome or an award is flagged as used, it is prevented from further selection from its respective pool or set; that is, the system does not select that game outcome or award upon another game outcome and/or award request. The system provides the selected game outcome and/or award.

In certain embodiments, the system determines a predetermined game outcome and/or award based on the results of a bingo, keno, or lottery game. In certain such embodiments, the system utilizes one or more bingo, keno, or lottery games to determine the predetermined game outcome and/or award provided for a primary game and/or a secondary game. The system is provided or associated with a bingo card. Each bingo card consists of a matrix or array of elements, wherein each element is designated with separate indicia. After a bingo card is provided, the system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards.

In certain embodiments in which the system includes a server and a streaming device and/or a client device, the streaming device and/or the client device is configured to communicate with the server for monitoring purposes only. In such embodiments, the streaming device and/or the client device determines the game outcome(s) and/or award(s) to be provided in any of the manners described above, and the server monitors the activities and events occurring on the streaming device and/or the client device. In one such embodiment, the system includes a real-time or online accounting and gaming information system configured to communicate with the server. In this embodiment, the accounting and gaming information system includes: (a) a user database configured to store user profiles, (b) a player tracking module configured to track users (as described below), and (c) a credit system configured to provide automated transactions.

As noted above, in various embodiments, the system includes one or more executable game programs executable by at least one processor of the system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the system. In certain such embodiments, the system includes one or more paylines associated with the reels. The example streaming device and/or client device 2000b shown in FIG. 4B includes a payline 2152 and a plurality of reels 2154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The system enables a wager to be placed on one or more of such paylines to activate such paylines. In other embodiments in which one or more paylines are formed between at least two adjacent symbol display areas, the system enables a wager to be placed on a plurality of symbol display areas, which activates those symbol display areas.

In various embodiments, the system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement. In certain embodiments, the system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided. In various embodiments, the system includes a progressive award. Typically, a progressive award includes an initial amount and an additional amount funded through a portion of each wager placed to initiate a play of a primary game. When one or more triggering events occurs, the system provides at least a portion of the progressive award. After the system provides the progressive award, an amount of the progressive award is reset to the initial amount and a portion of each subsequent wager is allocated to the next progressive award.

As generally noted above, in addition to providing winning credits or other awards for one or more plays of the primary game(s), in various embodiments the system provides credits or other awards for one or more plays of one or more secondary games. The secondary game typically enables an award to be obtained addition to any award obtained through play of the primary game(s). The secondary game(s) typically produces a higher level of user excitement than the primary game(s) because the secondary game(s) provides a greater expectation of winning than the primary game(s) and is accompanied with more attractive or unusual features than the primary game(s). The secondary game(s) may be any type of suitable game, either similar to or completely different from the primary game. In various embodiments, the system automatically provides or initiates the secondary game upon the occurrence of a triggering event or the satisfaction of a qualifying condition. In other embodiments, the system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. Any suitable triggering event or qualifying condition or any suitable combination of a plurality of different triggering events or qualifying conditions may be employed.

In other embodiments, at least one processor of the system randomly determines when to provide one or more plays of one or more secondary games. In one such embodiment, no apparent reason is provided for providing the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the system determines qualification for a secondary game at least partially based on a game triggered or symbol triggered event, such as at least partially based on play of a primary game. In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game. In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the system includes a plurality of streaming devices and/or client devices, the streaming devices and/or the client devices are configured to communicate with one another to provide a group gaming environment. In certain such embodiments, the streaming devices and/or the client devices enable users of those streaming devices and/or client devices to work in conjunction with one another, such as by enabling the users to play together as a team or group, to win one or more awards. In other such embodiments, the streaming devices and/or the client devices enable users of those streaming devices and/or client devices to compete against one another for one or more awards. In one such embodiment, the streaming devices and/or the client devices enable the users of those streaming devices and/or client devices to participate in one or more gaming tournaments for one or more awards.

In various embodiments, the system includes one or more player tracking systems. Such player tracking systems enable operators of the system (such as casinos or other gaming establishments) to recognize the value of customer loyalty by identifying frequent customers and rewarding them for their patronage. Such a player tracking system is configured to track a user's gaming activity. In one such embodiment, the player tracking system does so through the use of player tracking cards. In this embodiment, a user is issued a user identification card that has an encoded user identification number that uniquely identifies the user. When the user's playing tracking card is inserted into a card reader of the system to begin a gaming session, the card reader reads the user identification number off the player tracking card to identify the user. The system timely tracks any suitable information or data relating to the identified user's gaming session. The system also timely tracks when the player tracking card is removed to conclude play for that gaming session. In another embodiment, rather than requiring insertion of a player tracking card into the card reader, the system utilizes one or more portable devices, such as a mobile phone, a radio frequency identification tag, or any other suitable wireless device, to track when a gaming session begins and ends. In another embodiment, the system utilizes any suitable biometric technology or ticket technology to track when a gaming session begins and ends.

In such embodiments, during one or more gaming sessions, the system tracks any suitable information or data, such as any amounts wagered, average wager amounts, and/or the time at which these wagers are placed. In different embodiments, for one or more users, the player tracking system includes the user's account number, the user's card number, the user's first name, the user's surname, the user's preferred name, the user's player tracking ranking, any promotion status associated with the user's player tracking card, the user's address, the user's birthday, the user's anniversary, the user's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device.

In various embodiments, the system includes one or more servers configured to communicate with a personal gaming device—such as a smartphone, a tablet computer, a desktop computer, or a laptop computer—to enable web-based game play using the personal gaming device. In various embodiments, the user must first access a gaming website via an internet browser of the personal gaming device or execute an application (commonly called an “app”) installed on the personal gaming device before the user can use the personal gaming device to participate in web-based game play. In certain embodiments, the one or more servers and the personal gaming device operate in a thin-client environment. In these embodiments, the personal gaming device receives inputs via one or more input devices (such as a touch screen and/or physical buttons), the personal gaming device sends the received inputs to the one or more servers, the one or more servers make various determinations based on the inputs and determine content to be displayed (such as a randomly determined game outcome and corresponding award), the one or more servers send the content to the personal gaming device, and the personal gaming device displays the content.

In certain such embodiments, the one or more servers must identify the user before enabling game play on the personal gaming device (or, in some embodiments, before enabling monetary wager-based game play on the personal gaming device). In these embodiments, the user must identify herself to the one or more servers, such as by inputting the user's unique username and password combination (or in any other manners described above.

Once identified, the one or more servers enable the user to establish an account balance from which the user can draw credits usable to wager on plays of a game. In certain embodiments, the one or more servers enable the user to initiate an electronic funds transfer to transfer funds from a bank account to the user's account balance. In other embodiments, the one or more servers enable the user to make a payment using the user's credit card, debit card, or other suitable device to add money to the user's account balance. In other embodiments, the one or more servers enable the user to add money to the user's account balance via a peer-to-peer type application, such as PayPal or Venmo. The one or more servers also enable the user to cash out the user's account balance (or part of it) in any suitable manner, such as via an electronic funds transfer or by initiating creation of a paper check that is mailed to the user.

In certain embodiments, the one or more servers include a payment server that handles establishing and cashing out users'account balances and a separate game server configured to determine the outcome and any associated award for a play of a game. In these embodiments, the game server is configured to communicate with the personal gaming device and the payment device, and the personal gaming device and the payment device are not configured to directly communicate with one another. In these embodiments, when the game server receives data representing a request to start a play of a game at a desired wager, the game server sends data representing the desired wager to the payment server. The payment server determines whether the user's account balance can cover the desired wager (i.e., includes a monetary balance at least equal to the desired wager).

If the payment server determines that the user's account balance cannot cover the desired wager, the payment server notifies the game server, which then instructs the personal gaming device to display a suitable notification to the user that the user's account balance is too low to place the desired wager. If the payment server determines that the user's account balance can cover the desired wager, the payment server deducts the desired wager from the account balance and notifies the game server. The game server then determines an outcome and any associated award for the play of the game. The game server notifies the payment server of any nonzero award, and the payment server increases the user's account balance by the nonzero award. The game server sends data representing the outcome and any award to the personal gaming device, which displays the outcome and any award.

In certain embodiments, the one or more servers enable web-based game play using a personal gaming device only if the personal gaming device satisfies one or more jurisdictional requirements. In one embodiment, the one or more servers enable web-based game play using the personal gaming device only if the personal gaming device is located within a designated geographic area (such as within certain state or county lines). In this embodiment, the geolocation module of the personal gaming device determines the location of the personal gaming device and sends the location to the one or more servers, which determine whether the personal gaming device is located within the designated geographic area. In various embodiments, the one or more servers enable non-monetary wager-based game play if the personal gaming device is located outside of the designated geographic area.

In various embodiments, the system includes a streaming device and/or a client device configured to communicate with a personal gaming device—such as a smartphone, a tablet computer, a desktop computer, or a laptop computer—to enable tethered mobile game play using the personal gaming device. Generally, in these embodiments, the streaming device and/or the client device establishes communication with the personal gaming device and enables the user to play games on the streaming device and/or the client device remotely via the personal gaming device. In certain embodiments, the system includes a geo-fence system that enables tethered game play within a particular geographic area but not outside of that geographic area.

In certain embodiments, the system is configured to communicate with a social network server that hosts or partially hosts a social networking website via a data network (such as the internet) to integrate a user's gaming experience with the user's social networking account. This enables the system to send certain information to the social network server that the social network server can use to create content (such as text, an image, and/or a video) and post it to the user's wall, newsfeed, or similar area of the social networking website accessible by the user's connections (and in certain cases the public) such that the user's connections can view that information. This also enables the system to receive certain information from the social network server, such as the user's likes or dislikes or the user's list of connections. In certain embodiments, the system enables the user to link the user's user account to the user's social networking account(s). This enables the system to, once it identifies the user and initiates a gaming session (such as via the user logging in to a website (or an application) on the user's personal gaming device or via the user inserting the user's player tracking card into a streaming device and/or a client device), link that gaming session to the user's social networking account(s). In other embodiments, the system enables the user to link the user's social networking account(s) to individual gaming sessions when desired by providing the required login information.

For instance, in one embodiment, if a user wins a particular award (e.g., a progressive award or a jackpot award) or an award that exceeds a certain threshold (e.g., an award exceeding $1,000), the system sends information about the award to the social network server to enable the server to create associated content (such as a screenshot of the outcome and associated award) and to post that content to the user's wall (or other suitable area) of the social networking website for the user's connections to see (and to entice them to play). In another embodiment, if a user joins a multiuser game and there is another seat available, the system sends that information to the social network sever to enable the server to create associated content (such as text indicating a vacancy for that particular game) and to post that content to the user's wall (or other suitable area) of the social networking website for the user's connections to see (and to entice them to fill the vacancy). In another embodiment, if the user consents, the system sends advertisement information or offer information to the social network server to enable the social network server to create associated content (such as text or an image reflecting an advertisement and/or an offer) and to post that content to the user's wall (or other suitable area) of the social networking website for the user's connections to see. In another embodiment, the system enables the user to recommend a game to the user's connections by posting a recommendation to the user's wall (or other suitable area) of the social networking website.

Certain of the devices or components of the present disclosure, such as streaming devices and/or client devices located in a casino or another gaming establishment, include certain components and/or are configured to operate in certain manners that differentiate these systems from general purpose computing devices.

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general-purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general-purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general-purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general-purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the user, the EGM stores the pre-power failure state in a non-volatile memory, returns to that state upon restoration of power, and provides the award to the user. This requirement affects the software and hardware design on EGMs. General purpose computing devices are not state-based machines, and a majority of data is usually lost when a malfunction occurs on a general-purpose computing device.

A second difference between EGMs and general-purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a user of an EGM from manipulating the EGM's hardware and software in a manner that gives him an unfair, and in some cases illegal, advantage.

A third difference between EGMs and general-purpose computing devices is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general-purpose computing devices is that EGMs have unique peripheral device requirements that differ from those of a general-purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general-purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the user's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a user is required to make a number of selections on a video display screen. When a malfunction has occurred after the user has made one or more selections, the EGM may be restored to a state that shows the graphical presentation just before the malfunction including an indication of selections that have already been made by the user. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a user may decide that in a previous game of chance that they did not receive credit for an award that they believed they won. The game history information may be used to reconstruct the state of the EGM before, during, and/or after the disputed game to demonstrate whether the user was correct or not in the user's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third-party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general-purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention claimed is:

1. A system comprising:
a processor; and
a memory device that stores a plurality of instructions that, when executed by the processor, cause the processor to:
receive, from a streaming device, data associated with first content corresponding to an event,
determine whether any content modification events occur in association with the data received from the streaming device, and
responsive to the determination being that a content modification event occurred in association with the data received from the streaming device:
automatically modify the first content corresponding to the event to second, different content corresponding to the event, wherein at least one of the determination and the automatic modification occur based on a use of an artificial intelligence model, and
communicate the second, different content corresponding to the event to a device.

2. The system of claim 1, wherein the event comprises a play of a game associated with the streaming device.

3. The system of claim 1, wherein a game outcome associated with the play of the game is independent of any modification of the first content to the second, different content.

4. The system of claim 1, wherein the memory device stores a plurality of further instructions that, when executed by the processor, cause the processor to use the artificial intelligence model to correlate the data associated with the first content to a content data cluster to determine whether any content modification events occur.

5. The system of claim 4, wherein the content data cluster is associated with an identified user.

6. The system of claim 1, wherein the memory device stores a plurality of further instructions that, when executed by the processor, cause the processor to use the artificial intelligence model to correlate the data associated with the first content to a content data cluster to automatically modify the first content corresponding to the event to the second, different content corresponding to the event.

7. The system of claim 6, wherein the content data cluster is associated with an identified user.

8. The system of claim 1, wherein the automatic modification occurs in association with the artificial intelligence model enabling an independent server to generate the modified content.

9. The system of claim 1, wherein a user of the device is associated with a streaming subscription.

10. A system comprising:
a processor; and
a memory device that stores a plurality of instructions that, when executed by the processor, cause the processor to:
receive, from a streaming device, data associated with first content corresponding to an event, and
responsive to a content modification event occurring in association with the data received from the streaming device:
automatically modify, based on a first use of an artificial intelligence model, the first content corresponding to the event to second, different content corresponding to the event,
communicate the second, different content corresponding to the event to a first device,
automatically modify, based on a second use of the artificial intelligence model, the first content corresponding to the event to third, different content corresponding to the event,
communicate the third, different content corresponding to the event to a second device.

11. The system of claim 10, wherein the content modification event occurs based on a third use of the artificial intelligence model.

12. A method of operating a system, the method comprising:
receiving, from a streaming device, data associated with first content corresponding to an event,
determining, by a processor, whether any content modification events occur in association with the data received from the streaming device, and
responsive to the determination being that a content modification event occurred in association with the data received from the streaming device:
automatically modifying, by the processor, the first content corresponding to the event to second, different content corresponding to the event, wherein at least one of the determination and the automatic modification occur based on a use of an artificial intelligence model, and
communicating the second, different content corresponding to the event to a device.

13. The method of claim 12, wherein the event comprises a play of a game associated with the streaming device.

14. The method of claim 12, wherein a game outcome associated with the play of the game is independent of any modification of the first content to the second, different content.

15. The method of claim 12, further comprising using the artificial intelligence model to correlate the data associated with the first content to a content data cluster to determine whether any content modification events occur.

16. The method of claim 15, wherein the content data cluster is associated with an identified user.

17. The method of claim 12, further comprising using the artificial intelligence model to correlate the data associated with the first content to a content data cluster to automatically modify the first content corresponding to the event to the second, different content corresponding to the event.

18. The method of claim 17, wherein the content data cluster is associated with an identified user.

19. The method of claim 12, wherein the automatic modification occurs in association with the artificial intelligence model enabling an independent server to generate the modified content.

20. The method of claim 12, wherein a user of the device is associated with a streaming subscription.
